(19) United States
(12) Patent Application Publication
(10) Pub. No.: US 2026/0187779 A1
(43) Pub. Date: Jul. 2, 2026

(54) ROBOT ASSISTED IMAGING AND PIXEL DEGRADATION CLASSIFICATION

(71) Applicant: Assurant, Inc., New York, NY (US)

(72) Inventors: Nathaniel Payne, Knoxville, TN (US); Namo Nadir, Murfreesboro, TN (US); Najib Seguias-Bandry, Murfreesboro, TN (US); Skylar Raney, Nashville, TN (US)

(21) Appl. No.: 19/436,866

(22) Filed: Dec. 30, 2025

Related U.S. Application Data
(60) Provisional application No. 63/740,381, filed on Dec. 31, 2024.
(60) Provisional application No. 63/740,387, filed on Dec. 31, 2024.

(51) Int. Cl. G06T 7/00; B25J 9/16; G06T 7/80; G06V 10/26; G06V 10/50; G06V 10/70; G06V 10/764; G06V 10/774; G06V 10/82; H04N 23/73

(52) U.S. Cl. CPC G06T 7/0004; B25J 9/1697; G06T 7/80; G06V 10/273; G06V 10/507; G06V 10/764; G06V 10/774; G06V 10/82; G06V 10/87; G06T 2207/20081; G06T 2207/20084; G06T 2207/30168; G06V 2201/02; G06V 2201/06; H04N 23/73

(57) ABSTRACT

Embodiments of the present disclosure provide for robot assisted imaging and pixel degradation classification. Such embodiments may include adjusting one or more display settings for a screen of a mobile device based at least in part on one or more mobile device attributes associated with the mobile device to provide a test-enabled version of the screen, capturing at least one image of the test-enabled version of the screen via an image capture device, applying a neural network model to the at least one image to determine a pixel degradation classification for the screen; and determining a screen condition for the screen based at least in part on the pixel degradation classification for the screen.

### CROSS-REFERENCE TO RELATED APPLICATIONS

This application claims the benefit of and priority to U.S. Provisional Application No. 63/740,387, titled “ROBOT ASSISTED IMAGING AND PIXEL DEGRADATION CLASSIFICATION,” and filed on Dec. 31, 2024, and U.S. Provisional Application No. 63/740,381 , titled “A ROBOTIC SYSTEM FOR ROBOT ASSISTED IMAGING AND PIXEL DEGRADATION CLASSIFICATION,” and filed on Dec. 31, 2024, the entireties of which are hereby incorporated by reference herein.

### TECHNOLOGICAL FIELD

Embodiments of the present disclosure generally relate to computer technology, and more particularly to robot assisted imaging and to capture and/or analysis of an image of a mobile device to provide screen condition detection for the mobile device.

### BACKGROUND

Computer vision enables computers to see and understand an image. In some instances, computer vision may be used to detect and analyze the content of an image, such as recognizing an object within an image. However, existing technology is inadequate to meet the speed and precision requirements for certain computer vision tasks beyond recognizing an object within an image. Existing technologies may also be inadequate for the precision, accuracy, and speed needed for high throughput environments. Moreover, human analysis is incapable of the speed and precision required for computer vision tasks beyond recognizing an object within an image. As such, there is a need for improvement in computer vision techniques and technology to enable sophisticated image processing for a computer vision task. Through applied effort, ingenuity, and innovation, Applicant has solved many of these identified problems by developing embodied in the present disclosure, which are described in detail below.

### BRIEF SUMMARY

In an embodiment, an apparatus is provided. The apparatus comprises one or more processors and one or more storage devices storing instructions. In one or more embodiments, the instructions are operable, when executed by the one or more processors, to cause the one or more processors to adjust one or more display settings for a screen of a mobile device based at least in part on one or more mobile device attributes associated with the mobile device to provide a test-enabled version of the screen. In one or more embodiments, the instructions are additionally or alternatively operable, when executed by the one or more processors, to cause the one or more processors to capture at least one image of the test-enabled version of the screen via an image capture device. In one or more embodiments, the instructions are additionally or alternatively operable, when executed by the one or more processors, to cause the one or more processors to apply a neural network model to the at least one image to determine a pixel degradation classification for the screen. In one or more embodiments, the instructions are additionally or alternatively operable, when executed by the one or more processors, to cause the one or more processors to determine a screen condition for the screen based at least in part on the pixel degradation classification for the screen.

In another embodiment, a computer-implemented method is provided. In one or more embodiments, the computer-implemented method comprises adjusting one or more display settings for a screen of a mobile device based at least in part on one or more mobile device attributes associated with the mobile device to provide a test-enabled version of the screen. In one or more embodiments, the computer-implemented method additionally or alternatively comprises capturing at least one image of the test-enabled version of the screen via an image capture device. In one or more embodiments, the computer-implemented method additionally or alternatively comprises applying a neural network model to the at least one image to determine a pixel degradation classification for the screen. In one or more embodiments, the computer-implemented method additionally or alternatively comprises determining a screen condition for the screen based at least in part on the pixel degradation classification for the screen.

In yet another embodiment, a computer program product is provided. The computer program product is stored on at least one computer readable medium comprising instructions. In one or more embodiments, the instructions, when executed by one or more computers, cause the one or more computers to adjust one or more display settings for a screen of a mobile device data based at least in part on one or more mobile device attributes associated with the mobile device to provide a test-enabled version of the screen. In one or more embodiments, the instructions, when executed by the one or more computers, additionally or alternatively cause the one or more computers to capture at least one image of the test-enabled version of the screen via an image capture device. In one or more embodiments, the instructions, when executed by the one or more computers, additionally or alternatively cause the one or more computers to apply a neural network model to the at least one image to determine a pixel degradation classification for the screen. In one or more embodiments, the instructions, when executed by the one or more computers, additionally or alternatively cause the one or more computers to determine a screen condition for the screen based at least in part on the pixel degradation classification for the screen.

In another embodiment, a robotic system is provided. The robotic system comprises a robot arm, an image capture device, and one or more computing devices. The robot arm comprises an end effector configured to engage a mobile device. The image capture device is connected to and movable with at least a portion of the robot arm. The one or more computing devices comprise one or more processors and one or more storage devices storing instructions. The instructions are operable, when executed by the one or more processors, to cause the one or more processors to cause the image capture device to capture at least one image of a screen of the mobile device. In one or more embodiments, the instructions are additionally or alternatively operable, when executed by the one or more processors, to cause the one or more processors to apply the at least one image to a trained model to determine a condition of the screen.

In another embodiment, a computer-implemented method is provided. In one or more embodiments, the computer-implemented method comprises capturing at least one image of a screen of a mobile device with an image capture device connected to and movable with at least a portion of a robot arm. In one or more embodiments, the computer-implemented method additionally or alternatively comprises applying the at least one image to a trained model to determine a condition of the screen.

In yet another embodiment, a computer program product is provided. The computer program product is stored on at least one computer readable medium comprising instructions. In one or more embodiments, the instructions, when executed by one or more computers, cause the one or more computers to capture at least one image of a screen of a mobile device with an image capture device connected to and movable with at least a portion of a robot arm. In one or more embodiments, the instructions, when executed by the one or more computers, additionally or alternatively cause the one or more computers to apply the at least one image to a trained model to determine a condition of the screen.

Various other embodiments are also described in the following detailed description and in the attached claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Having thus described the embodiments of the disclosure in general terms, reference now will be made to the accompanying drawings, which are not necessarily drawn to scale, and wherein:

FIG. 1 illustrates a block diagram of a system that may be specially configured within which at least one example embodiment of the present disclosure may operate;

FIG. 2 illustrates a block diagram of an example apparatus that may be specially configured in accordance with at least one example embodiment of the present disclosure;

FIG. 3 illustrates a perspective view of a mobile device engagement system in accordance with various embodiments of the present disclosure;

FIG. 4 illustrates a side view of a mobile device engagement system in accordance with various embodiments of the present disclosure;

FIG. 5 illustrates a mobile device engagement system holding a mobile device over a station in accordance with various embodiments of the present disclosure;

FIG. 6 illustrates a mobile device being engaged with an electrical connector of a station in accordance with various embodiments of the present disclosure;

FIG. 7 illustrates a bank of stations in accordance with various embodiments of the present disclosure;

FIG. 8 illustrates an end effector assembly in accordance with various embodiments of the present disclosure;

FIGS. 9A-9C illustrate a set of example images associated with screen condition detection in accordance with various embodiments of the present disclosure;

FIGS. 10A-10F illustrate another set of example images associated with screen condition detection in accordance with various embodiments of the present disclosure;

FIG. 11 illustrates an example process depicting example operations for providing screen condition detection associated with a screen of mobile device in accordance with at least one embodiment of the present disclosure; and

FIG. 12 illustrates an example process depicting example operations for providing screen condition detection associated with a screen of mobile device in accordance with at least one embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

An image processing system may be utilized to enable review of images of an object to verify the integrity of the object (e.g., to determine information about the object, to verify the operability or functionality of the object, to verify the identity of the object, or the like). Human analysis and/or computer vision is typically utilized to verify the integrity of the object using the images provided by the image processing system. However, human analysis is incapable of the speed, accuracy, and precision required for computer vision tasks, particularly in high throughput, high-volume facilities. Additionally, it is often difficult for computer vision and/or image processing to occur within a desirable interval of time and/or within a certain degree of precision. Moreover, typical image processing systems cannot directly control an image capture process. Thus, typical image processing systems inadequately account for and/or detect issues with an image capture process (e.g., via lack of standardization, accuracy, or precision caused by inadequately trained or executed models).

To account for such technical problems associated with typical image processing systems and/or typical computer vision systems, embodiments of the present disclosure provide improved image processing and/or computer vision techniques using machine learning. Embodiments of the present disclosure may include improved image capture hardware and software techniques, including robot assisted image capture and improved image capture device calibration, which in turn may additionally improve the aforementioned image processing and/or computer vision techniques.

In various embodiments, screen condition detection for a mobile device or another type of display device is provided using machine learning. For example, burn-in detection and/or bruising detection associated with a screen of a mobile device may be provided via machine learning. In various embodiments, a mobile device engagement system is further utilized to enable automated functionality for the image processing and/or computer vision disclosed herein for providing screen condition detection for a mobile device. For example, the image processing and/or computer vision disclosed herein may be provided as a diagnostic test in the mobile device engagement system to enable screen condition detection for a mobile device.

The mobile device engagement system may include a robot with a robot arm (e.g., a multi-axis robot arm, such as a six axis arm) having an end effector thereon configured to manipulate one or more objects (e.g., mobile device(s)). Additionally, one or more image capture devices may be attached to the robot arm. The image capture device(s) may be movable by the robot arm to capture images of one or more objects (e.g., mobile device(s)). The robot arm may engage and facilitate positioning of the mobile device to provide a connection between a port of the mobile device and an electrical connector of the mobile device engagement system and/or to control imaging of the mobile device. In response to the port of the mobile device being connected to the electrical connector of the mobile device engagement system, a screen of the mobile device may be turned on, an image of the screen of the mobile may be captured via the one or more image capture devices attached to the robot arm, and a trained machine learning model may be utilized to determine a screen condition for the mobile device. For example, the trained machine learning model may be utilized to determine whether the screen of the mobile device comprises a burn-in condition and/or a bruising condition.

In various embodiments, after engaging the port of the mobile device with the electrical connector and/or determination of a successful communication with the mobile device (e.g., by receiving signals from the mobile device over the electrical connector), one or more computer-executable instructions may be performed on the mobile device. For example, an application for diagnostics related to screen condition detection for the mobile device may be installed and/or initiated via the mobile device. In various embodiments, the one or more image capture devices may capture an image of the screen of the mobile device after engagement between the mobile device and the electrical connector and establishment of an electronic coupling (e.g., a data connection). Accordingly, embodiments of the present disclosure provide flexible, rapid (e.g., real-time or near real-time) inspection and verification of a mobile device via the processes, systems, apparatuses, and/or computer program products described herein that provide screen condition detection for the mobile device. In some embodiments, one or more of the aforementioned features may be added without departing from the scope of the disclosure, but each may be omitted while maintaining sufficient security, accuracy, and speed due to the processes, systems, apparatuses, and/or computer program products described herein. While various embodiments herein use a “mobile device” for illustrative examples of the systems and processes of the present disclosure, it is to be appreciated that the mobile device may be interchanged with other such computing devices comprising a screen (e.g., a tablet, a standalone display screen, etc.).

In various embodiments of the present disclosure, a mobile device or the like may be inspected for at least externally detectable defects such as defects on a screen. Such inspection processes may be particularly useful for high-throughput, high-volume mobile device processing systems, such as a reverse logistics system. In such instances, manual screening, whether in person or using a captured image, is incapable of meeting the precision and speed required to verify the integrity of the mobile device in a reasonable time, and therefore the systems, methods, and/or apparatuses described herein may be utilized for improved analysis of a condition of a mobile device. Other use cases of the screen condition detection processes and systems described herein can be appreciated by one skilled in the art in light of the present disclosure.

The screen condition detection disclosed herein may additionally or alternatively provide one or more other improved efficiencies over traditional image processing systems, robot control systems, and robot assisted imaging. Such improvements may include, but are not limited to; reduced processor loads for a mobile device and/or a server, such as by loading one or more lean pretrained neural networks onto a device for efficient processing, by removing unnecessary software installation and storage steps, by handling at least a portion of certain data heavy tasks locally at the image capture device, by handling at least a portion of certain data heavy tasks via a server rather than a local device, by optimizing imaging process functionality for capturing an image of a mobile device, etc. ; reduced computing resources for a mobile device and/or a server that cause little to no downtime for any other computing resource when modified, added, or removed, such as by removing unnecessary software installation and storage steps at a local device by offloading various functionalities at a server and/or another mobile device, handling at least a portion of certain data heavy tasks via a server rather than a local device, etc. ; holistic image processing facilitating improved processing of images, such as by providing real-time configuring of one or more settings of an image capture device, etc. ; optimized machine learning modeling associated with images, such as by retraining a machine learning model based on results of a screen condition detection process, etc. ; more accurate machine learning models via improved training and input data; and the like.

### Definitions

In some embodiments, some of the operations above may be modified or further amplified. Furthermore, in some embodiments, additional optional operations may be included. Modifications, amplifications, or additions to the operations above may be performed in any order and in any combination.

As used herein, the terms “data,” “content,” “digital content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “data packet” refers to a collection of data including data structures and/or individual data elements that is transmittable between a plurality of computing entities (e.g., mobile devices, servers, systems, and/or the like) collectively, such that the included data (e.g., data structures, data elements) remains associated therewith. The data packet is configured to store data therein with a standardized formatting, such that computing entities are able to automatically determine the type of data stored within the data packet. For example, a data packet comprise substantive data stored within a payload of the data packet that is to be passed between computing entities, as well as metadata associated with the generation of the data packet that is stored within a routing data portion of the data packet.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer may read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

The term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

The term “electronically coupled,” “electronically coupling,” “electronically couple,” “in electronic communication with,” or “electronically connected” in the present disclosure refers to two or more elements or components being electronically connected, directly or indirectly. For example, two or more elements or components may be connected through wired means and/or wireless means, such that signals, voltage/current, data, information, or any other electronic signals may be transmitted to and/or received from these elements or components. Electronic connections established via an electrical connector and/or port may refer to wired connections.

The term “mechanically coupled” in the present disclosure refers to two or more mechanical elements (for example, but not limited to, a frame, a surface, a support unit, a joint, etc.) being physically connected in various ways such as directly, through intermediary elements, and/or using fastener(s), clasps, clamps, joints, pin joint, axle, hinge, adhesive, etc. The term “mechanically coupled” may refer to any of movable, turntable, swiveling, pivoting, fixed, and/or stationary mechanical coupling and/or any other similar type of mechanical coupling. In a non-limiting example, two components are mechanically coupled using a force, such as but not limited to magnetic force, force caused by air pressure, adhesive force, mechanical force, and/or other similar or related forces.

The term “mobile device” refers to computer hardware and/or software that is configured to access a service made available by a server. The server is often (but not always) on another computer system, in which case the mobile device accesses the service by way of a network. Mobile devices may include, without limitation, smart phones, tablet computers, laptop computers, wearables, virtual reality devices, augmented reality devices, handheld gaming devices, personal computers, enterprise computers, and the like. Wearables may include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like. In various embodiments, a mobile device may be a portable computing device with one or more communications, networking, and/or interfacing capabilities. Non-limiting examples of communications, networking, and/or interfacing capabilities include CDMA, TDMA, 4G, 5G, NFC, Wi-Fi, Bluetooth, as well as hard-wired connection interfaces such as USB, Thunderbolt, and/or ethernet connections. In some embodiments, the mobile device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, a mobile device may include computer hardware and/or software that is configured to access a component made available by a server. The server is often, but not always, on another computer system, in which case the client accesses the component by way of a network.

The term “image capture device” refers to a device that includes one or more image capture sensors for capturing one or more images and/or video. For example, an image capture device may be camera or another type of image capture device that is configured to capture one or more images and/or video. In some embodiments, an image capture device may be included in and/or communicatively coupled to a mobile device. For example, an image capture device may be a front facing image capture sensor (e.g., a camera) configured on the same side of the mobile device as a display screen, a rear facing image capture sensor (e.g., a camera) on a rear surface of the mobile device (e.g., on a side of the mobile device lacking a display screen), or another image capture sensor of a mobile device. In some embodiments, an image capture device is configured to capture one or more portions of image data, collect distance and/or dimension data, scan a code data, etc., including data related to, but not limited to, a mobile device. An image capture device may include various types of cameras such as a photographic and/or videographic camera, a one-two-or three-dimensional camera, a LIDAR image capture device, a radar image capture device, a sound-wave image capture device, a bar-code reader, a two-dimensional scanner, a three-dimensional scanner, an optical scanner, a laser scanner, an infrared scanner, (each of the foregoing examples not necessarily being mutually exclusive) or any other device capable of imaging the object for one or more of the respective functions described herein. Additionally, the image capture device may function using various light wavelengths, for example, but not limited to, visible light wavelengths, infrared (IR) light wavelengths, and/or Ultraviolet (UV) light wavelengths. In some embodiments, the image capture device may function using a light source and/or using ambient light. In some embodiments, the image capture device may capture one or more types of image data including, but not limited to, one or more images (e.g., one or more still photos, one or more bursts photos, etc.) and/or one or more videos. In some embodiments, an image of a mobile device captured by an image capture device may be any of a photographic image, (such as a JPEG, HEIF, TIFF, RAW, DNG, PNG, GIF, BMP, etc., image), a frame of a video (such as a MP4, MOV, WMV, AVI, AVCHD, FLV, F4V, SWF, MKV, WEBM, HTML5, etc., video), a point cloud, scanned data code stored in a form of a file containing data embedded in a code, and/or any other type of image or data file.

In some embodiments, the image capture device(s) may be customized for operation with a robot arm. For example, the image capture devices may define a narrower field of view than a traditional camera and/or a lower resolution (e.g., 2.5-5 megapixels) than a traditional camera, which may allow for sufficient image quality for use with the models discussed herein without excessive weight that may impede the operation of the robot arm. In any of the various embodiments discussed herein, the image capture device may be selected and/or modified (e.g., via software modification, such as a firmware or settings update) to have a framerate that matches a screen framerate of the mobile device(s) being captured. In some embodiments, separate image capture devices may be used for different mobile devices that have different framerates, and in some embodiments, the framerate of the camera may be changed depending on the mobile device being imaged.

The term “connection” refers to a data connection (e.g., an electronic connection) or link established between a port of a mobile device and an electrical connector of a mobile device engagement system. For example, a connection may be an electronic coupling between the two components that allows for data signals to be transmitted between them in one or both directions. In a non-limiting example, an electrical connector may be electronically coupled with a port of a mobile device and the data connection may exist between the electrical connector and the mobile device when data signals are able to transmit between the electrical connector and the port of the mobile device.

The term “electrical connector” refers to a connector that comprises a conductive material and is configured to mechanically and electronically couple with, for example, a port of a mobile device and, in some instances, a data connection. In a non-limiting example, the electrical connector may be a connector or a plug that is configured to be inserted in and electrically coupled to a port of a mobile device to provide electrical and data connection to and/or from the mobile device. Non-limiting examples of an electrical connector includes a USB connector, a USB-C® connector, a USB Micro-B connector, a lightning® connector, and/or similar connectors.

The term “port” refers to a receptacle, jack, or socket configured to mechanically and electronically couple with, for example, an electrical connector. In some embodiments, the electrical connector may at least partially insert into the port. In a non-limiting example, a port on a mobile device may be used for charging and/or data transfer to/from the mobile device. Non-limiting examples of a port include USB port, a USB-C® port, a USB Micro-B port, a lightning® port, and/or similar ports.

The term “trained model” refers to one or more machine learning, algorithmic, and/or statistical models, or a combination thereof, for providing an inference, classification, and/or prediction associated with one or more portions of one or more computer-implemented processes associated with providing a screen condition status associated with a mobile device. A trained model may be a machine learning model that is trained, configured, and/or tuned for providing an inference, classification, and/or prediction associated with one or more portions of one or more computer-implemented processes associated with providing a screen condition status associated with a mobile device. In various embodiments, a trained model may be a damage detection model trained to detect damage to the mobile device in the image, a pixel degradation model trained to determine a pixel degradation classification for a set of pixels and/or a screen of a mobile device present in an image, a screen condition detection model trained to determine a screen condition for a screen of a mobile device present in an image, a mobile device presence model trained to detect whether a mobile device is present in an image, a cropping model trained to optionally crop the image, a device attribute model trained to determine one or more device attributes of a mobile device based on one or more physical features of the mobile device such as location of one or more lenses, device features, and/or other markings of the mobile device in an image, a cover detection model trained to detect a cover on a mobile device present in the image, a mobile device front/rear identification model trained to determine whether an image reflects the front or rear of the device, a mobile device authenticity model trained to determine whether the image includes the mobile device from which the image was captured, an image quality model trained to determine whether the image includes sufficient quality (e.g., without blurriness, etc.) for a screen condition status process, and/or another type of model trained for providing an inference, classification, and/or prediction associated with one or more portions of one or more computer-implemented processes associated with providing a screen condition status associated with a mobile device.

The term “machine learning model” refers to a data entity that describes parameters, hyper-parameters, and/or defined operations configured, trained, and/or the like to generate an output for a predictive task, a classification task, and/or a generative task using machine learning techniques. For example, a machine learning model may include one or more layers, one or more rule-based layers, one or more neural network layers, and/or one or more other types of layers that depend on trained parameters, coefficients, and/or the like. In some embodiments, machine learning model may be configured, trained, and/or the like to generate an output for a predictive task, a classification task, and/or a generative task for a predictive domain associated with providing a screen condition status associated with a mobile device. A machine learning model may include one or more of any type of machine learning model including one or more supervised, unsupervised, semi-supervised, reinforcement learning models, and/or the like. For instance, a machine learning model may include a supervised model that may be trained using a historical training dataset. In some examples, a machine learning model may include multiple models configured to perform one or more different stages of a classification and/or prediction process. In various embodiments, a machine learning model may be configured as a neural network model, a deep learning model, a convolutional neural network (CNN) model, a natural language processing (NLP) model, a large language model (LLM), a generative model, a transformer model, and/or another type of machine learning model. In some embodiments, a machine learning model may be designed and/or trained for a particular predictive domain associated with providing a screen condition status associated with a mobile device. In some embodiments, a machine learning model may be designed and/or trained to apply one or more machine learning techniques to a feature set associated with one or more images of a mobile device.

The term “screen condition” refers to a condition or status of a screen of a mobile device. For example, a screen condition may indicate whether or not a screen of a mobile device is associated with damage. Damage may include, but is not limited to, screen burn-in, screen bruising, crack(s), occlusion(s), water damage, dent(s), scratch(es), and/or any other damage associated with a screen of a mobile device. A screen condition may be determined, at least in part, by a pixel degradation classification. Damage may prevent one or more portions of a mobile device from operating properly. Additionally or alternatively, damage may prevent a mobile device from being qualified for, insured, or protected via a trade-in, an insurance plan, a warranty, a device protection plan, and/or another type of service for a mobile device. In various embodiments, a screen condition of a mobile device may be determined based on one or more images associated with the mobile device and/or a screen of the mobile device. In some embodiments, a screen condition of a mobile device may be determined based on a pixel degradation classification for a screen of the mobile device.

The term “pixel degradation classification” refers to a data construct that describes a classification regarding pixel degradation for a screen of a mobile device. For example, a pixel degradation classification may provide a prediction as to whether a pixel of a screen of a mobile device is associated with a particular type or degree of pixel degradation (e.g., burn-in, bruising, etc.). In some embodiments, a pixel degradation classification may be provided by a trained model such as a neural network model trained to determine a pixel degradation classification for a screen of a mobile device. Pixel degradation classification may refer to various outputs, including, but not limited to, a binary indication of the presence or absence of one or more types of pixel degradation (e.g., burn-in, bruising, etc.); a confidence level associated with the likelihood of one or more types of pixel degradation; a score or other variable output (e.g., a percentage or similar score) associated with a degree of pixel degradation; or the like. In some embodiments, a pixel degradation classification may be a cumulative score or other output based on an extent of pixel degradation across a screen. For example, a pixel degradation classification may comprise a score or other variable output associated with an extent of pixel degradation across a surface area of the screen (e.g., 50% damaged). In some embodiments, the pixel degradation classification may comprise an output based on one or more thresholds or other categories of classification (e.g., “highly damaged”, “moderately damaged”, “undamaged”, etc.). The pixel degradation classification may be determined by one or more models (e.g., a neural network) based on a training data set.

The term “display setting” refers to a setting for any configurable feature associated with a screen (e.g., a screen of a mobile device). Non-limiting examples of a display setting may include an exposure setting, a brightness setting, a color setting, a contrast setting, a frame rate setting, and/or another type of setting for configuring any display of visual data via a screen of a mobile device. In some embodiments, a display setting may be directly set, such as by adjusting one or more of the aforementioned settings via a menu of the device. In some embodiments, a display setting may be indirectly set, such as by causing a video or image to be displayed on a screen or by loading a software application configured to do the same. In some embodiments, the display setting may be set via any known process.

The terms “mobile device attribute” and “attribute” refer to a data construct that describes a device (e.g., a mobile device), including, but not limited to, a mobile device manufacturer, a mobile device model, a mobile device operating system, a mobile device software version, a current access permission level, mobile device dimensions, a grade, a type of screen, a combination thereof, and/or similar attributes. The mobile device attribute may but need not individually or uniquely identify a device. In some embodiments, the mobile device attribute may be configured to inform a procedure for adjusting one or more display settings of a screen of a device. For example, various makes, models, operating systems, etc. of mobile device may have different hardware and/or software protocols, different menu hierarchies, different available settings, and the like which may require at least partly different processes to cause change of the display setting thereof. For example, a mobile device running the IOS operating system may have a different menu adjustment process for changing a brightness of the screen than a mobile device running the ANDROID operating system. A repository associated with the various systems disclosed herein may comprise instruction sets for particular mobile device attributes. Similarly, in some embodiments, various physical stations of a mobile device engagement system 104 may have electrical connectors configured for a particular group of mobile devices associated with various mobile device attributes (e.g., a LIGHTNING form factor connector versus a USB C form factor connector).

The term “peripheral input device” refers to one or more input devices, whether such devices are physical devices and/or electronically simulated to give the appearance of a physical device to a mobile device. A physical input device may include any physical device that is capable of providing an input to the mobile device by touching a screen of the mobile device. For example, an end of the physical input device may include material that, when in physical contact with the screen, can imitate touching the screen of the mobile device or provide input to the mobile device. One or more peripheral input devices may be employed in connection to the mobile device, whether such connection is via physical connector (e.g., physical connector of a physical input device and/or physical connector associated with the computing device which simulates an input device over the physical connector) or otherwise. A peripheral input device may be electronically simulated using at least one computing device and interact with the mobile device during execution of one or more software steps. In a non-limiting example, the peripheral input device may interact with the mobile device in response to the at least one computing device analyzing and determining a type of a prompt and/or the location of the prompt on the screen of the mobile device. The at least one computing device may determine an appropriate response to the prompt and the appropriate way to communicate the response to the mobile device. For example, the at least one computing device may interact with the mobile device by communicating the appropriate response to the mobile device over the electrical connector, such as by simulating mouse inputs, touchscreen touches, and/or keyboard strokes on the mobile device.

Non-limiting examples of peripheral input devices include a tapping device, a touch device, a touch pen, a stylus, computer keyboards, computer mice, microphones, joysticks, touchpads, trackballs, a software run by the at least one computing device, and any other peripheral input devices capable of manipulating the mobile device whether electronically simulated or generated by physical corresponding input devices.

The term “test-enabled version of the screen” refers to a screen having one or more settings set for visual analysis. A test-enabled version of the screen may be a default setting applied universally to a plurality of mobile device screens or may be a customized setting for a subset of mobile device(s). In some embodiments, the test-enabled version of the screen may be a result of a preliminary visual analysis of the screen, such as capturing an initial image of the screen and adjusting a display setting (e.g., brightness, contrast, etc.) to achieve a standardized output for input to a trained model (e.g., a pixel degradation classification model). In some embodiments, the test-enabled version of the screen may be based on one or more mobile device attributes. For example, a wired or wireless instruction set may be sent to the mobile device to cause the display settings to be set. The wired or wireless instruction set may be generated based on a device make, model, operating system, etc., which may be configured based on the user interface and/or other software particularities of the mobile device. In some embodiments, the test-enabled version of the screen may be generated by one or more software applications running on the mobile device (e.g., a dedicated testing app or a testing interface accessed via a mobile web browser). In some embodiments, the test-enabled version of the screen may comprise a color and/or pattern, such as a white screen, a green screen, a checkered screen, or the like. In some embodiments, a test-enabled version of the screen may comprise disabling automatic screen control features, such as screen timeout and/or screen auto-brightness adjustment. For example, in some embodiments, a test-enabled version of the screen may comprise a maximum brightness setting of the screen (e.g., a maximum brightness white screen). In various embodiments, the test-enabled version of the screen may be defined by any modifiable feature of the screen.

The term “robot arm” refers to an electronically controlled mechanical device configured to perform one or more tasks with respect to one or more physical objects. For example, a robot arm may be configured to engage and facilitate positioning of a mobile device. A robot arm may further comprise a jointed mechanical structure to enable range of motion for engaging and positioning the mobile device. In some embodiments, a robot arm may comprise an end effector. For example, a robot arm may be configured to move according to one or more axes. In some embodiments, the robot arm may have one or more articulated joints. Furthermore, an end effector may be attached to the robot arm (e.g., at an end of the robot arm). In some embodiments, one or more image capture devices may be attached to a robot arm to facilitate capturing at least one image of a screen of a mobile device via the one or more image capture devices.

The term “end effector” refers to a portion or device of a robot arm including an engagement mechanism configured to engage an object such as a mobile device. In a non-limiting example, the end effector may for example include a suction device, a gripper, a grabbing tool, and/or other similar means. For example, an end effector of the robot arm may comprise a suction tool supplied with a vacuum from a compressor. In some examples, the end effector may include a gripper that pinches or otherwise grasps a target device. In some embodiments, an end effector may be configured to grasp a mobile device. For example, the end effector may be any known tool capable of engaging a mobile device. In some embodiments, the end effector may include other components, such as sensors. For example, an end effector may include a force sensor (e.g., a force torque sensor) and/or a pressure sensor configured to sense an amount of force/pressure applied to the engaged object (e.g., a mobile device).

The terms “engage”, “engaging”, or “engagement” refer to a mechanical contact or other interaction, including coupling, whether direct or indirect, between two or more components.

The term “force sensor” refers to an electrical, mechanical and/or electro-mechanical device configured to cause a detectable signal or change in signal indicative of a force applied to it or to a substrate to which the force sensor is applied. In some embodiments, the force sensor may generate or modify electromagnetic signals (e.g., via a change in resistance, current, voltage or the like, such as a strain gauge) configured to be received, detected, and/or quantified by a computing device. In some embodiments, the force sensor may be configured to output a measurement associated with the force (e.g., pounds of force). In various embodiments, the force sensor is configured to generate a signal to facilitate monitoring or detection of linear and/or rotational forces. In a non-limiting example, the force sensor is a force torque sensor, a pressure sensor, a multi-axis (e.g., a six axis) sensor, and/or similar sensors.

The term “station” refers to a docking area, location, site, terminal, base, etc., where the electrical connector is mounted, mechanically coupled to, or otherwise capable of interacting with a mobile device. In various embodiments, the station is configured to support and/or mechanically couple to the mobile device while the mobile device engages with the electrical connector.

The term “user interface” refers to a specifically structured interactive virtual environment that is configured for selective presentation of various data structures, as described herein. A user interface includes data rendered to a display screen of a mobile device that includes one or more interface elements visible to a user of the mobile device. In some embodiments, a user interface is interactable such that the use may perform various user interaction(s) with the one or more of the structured interface elements defined within the user interface, each of which may correspond to a unique functionality of the user interface. In particular, it should be appreciated that in various example contexts, a user interface provides access to particular functionality of the screen condition status system via one or more computing devices (e.g., initiation of one or more processes, communication with a remote processing server configured to perform particular functionality, and/or updating of renderings to a display). In some embodiments, a user interface is configured to render a data element, a data structure, and/or the like to facilitate user interaction with the rendered data.

### Example Systems

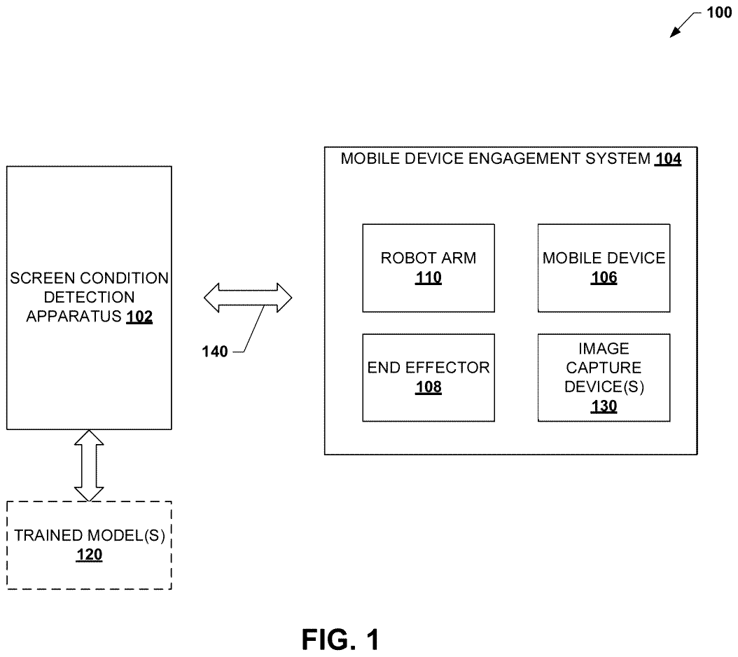

FIG. 1 illustrates a block diagram of a system that may be specially configured within which embodiments of the present disclosure may operate. Specifically, FIG. 1 illustrates an example system 100. The example system 100 includes at least a screen condition detection apparatus 102 and a mobile device engagement system 104. In some embodiments, the screen condition detection apparatus 102 may be implemented separate from the mobile device engagement system 104. In other embodiments, some or all of the screen condition apparatus (e.g., one or more computing device(s) and related hardware and software associated therewith) 102 may be placed inside the mobile device engagement system 104 and/or may use the same hardware and/or software components as other portions of the mobile device engagement system 104 described herein.

The mobile device engagement system 104 includes an end effector 108, a robot arm 110 that may include and manipulate the end effector, and/or one or more image capture devices 130. The robot arm 110 may be configured to engage and facilitate positioning of a mobile device 106 associated with the mobile device engagement system 104. For example, the mobile device 106 may be a device under test to determine a screen condition for a screen of the mobile device 106 via the screen condition detection apparatus 102. The end effector 108 may define a distal end portion of the robot arm 110 and may be attached to an upstream portion of the robot arm 110. The end effector 108 may be an engagement mechanism configured to engage the mobile device 106. For example, the end effector 108 may be a suction device, a gripper, a grabbing tool, and/or other type of engagement mechanism configured to engage the mobile device 106. The end effector 108 may be configured to lift and manipulate the mobile device 106 into multiple positions (e.g., to engage a port of the mobile device with an electrical connector of the mobile device engagement system 104. In some embodiments, the one or more image capture devices 130 may be attached to the robot arm 110 to facilitate capturing at least one image of a screen of the mobile device 106 via the one or more image capture devices 130. The one or more image capture devices 130 may be positioned at one or more locations along the length of the robot arm (e.g., at a location at the base of the robot arm, at or proximate the end effector, and/or various intermediate locations therebetween).

The screen condition detection apparatus 102 may be configured to utilize image processing and/or computer vision techniques to enable determining a screen condition for the screen of the mobile device 106. In some embodiments, screen condition detection apparatus 102 may be configured to utilize image processing and/or computer vision techniques associated with machine learning to enable determining a screen condition for the screen of the mobile device 106. For example, the screen condition detection apparatus 102 may be configured to process one or more images to determine pixel degradation classification for a screen. The screen condition detection apparatus 102 may be in communication with various components of the mobile device engagement system 104 via a connection 140. The connection 140 may be wired and/or wireless. In some embodiments, the mobile device engagement system 104 may be configured to receive and/or transmit data from/to the screen condition detection apparatus 102 to perform one or more steps/operations associated with the screen condition detection apparatus 102, as further described herein.

The screen condition detection apparatus 102 includes one or more computer(s) embodied in hardware, software, firmware, and/or a combination thereof. In some embodiments, the screen condition detection apparatus 102 embodies or includes a local device, an edge device, a frontend device, or the like for the mobile device engagement system 104. In some embodiments, the screen condition detection apparatus 102 includes one or more application server(s), database server(s), computing terminal(s), and/or the like that are configured to perform the functionality described herein. In some embodiments, the screen condition detection apparatus 102 embodies or includes a backend system (e.g., one or more enterprise server(s)) that are communicable over one or more network(s) (e.g., via the Internet). Additionally or alternatively, in some embodiments, the screen condition detection apparatus 102 includes one or more virtual computer(s) embodied in a software environment maintained via particular hardware, for example where the screen condition detection apparatus 102 is maintained as a virtual environment on hardware of a central terminal supporting multiple software application(s). In some embodiments, the screen condition detection apparatus 102 includes one or more hardware device(s) within the same physically defined space, such as within the mobile device engagement system 104. Alternatively or additionally, in some embodiments, the screen condition detection apparatus 102 includes one or more hardware and/or software device(s) located remotely from one another and that communicate in conjunction with one another to provide the described functionality, for example embodied by one or more cloud computing system(s).

In some embodiments, the screen condition detection apparatus 102 includes a plurality of sub-services that each support a portion of the functionality performed by the screen condition detection apparatus 102. In some embodiments, the plurality of sub-services may each be embodied by different hardware, software, firmware, and/or any combination thereof. Alternatively or additionally, in some embodiments, one or more of the sub-services share particular hardware, software, firmware, and/or any combination thereof. For example, in some embodiments, the screen condition detection apparatus 102 embody specially configured software applications executed on shared hardware.

In some embodiments, the screen condition detection apparatus 102 supports a screen condition detection process for providing a screen condition status associated with the mobile device 106. In some embodiments, the screen condition detection apparatus 102 supports functionality for managing a web browser session associated with the mobile device 106. In some embodiments, the screen condition detection apparatus 102 supports functionality for managing a software application and/or SDK downloaded on the mobile device 106. In some embodiments, the screen condition detection apparatus 102 supports functionality for rendering one or more user interfaces via a display screen of the mobile device 106 to facilitate the screen condition detection process.

In some embodiments, the screen condition detection apparatus 102 supports a computer-implemented process for managing a screen condition status associated with the mobile device 106. For example, the screen condition detection apparatus 102 may support a computer-implemented process that is executed based on data and/or instructions from a different entity, such as the one or more image capture devices 130 and/or functionality associated with the robot arm 110 and/or the end effector 108. In some embodiments, the screen condition detection apparatus 102 supports functionality for analyzing one or more images associated with a test-enabled version of a screen of the mobile device 106. In some embodiments, the screen condition detection apparatus 102 utilizes one or more trained models 120 to analyze the one or more images. For example, the one or more trained models 120 may be respectively trained, configured, and/or tuned for providing a classification, an inference, and/or prediction associated with one or more portions of the screen condition detection process. In some embodiments, at least one trained model of the one or more trained models 120 may be trained to determine a pixel degradation classification for a screen of the mobile device 106. In some embodiments, the one or more trained models 120 may be one or more machine learning models. For example, the one or more trained models 120 may be one or more neural network models. In some embodiments, the one or more trained models 120 may be executed remotely via a network (e.g., via a networked computing device, such as a server or other remote processing device). In other embodiments, the one or more trained models 120 may be executed locally on the screen condition detection apparatus 102. In other embodiments, a portion of the one or more trained models 120 may be executed remotely via a network and another portion of the one or more trained models 120 may be executed locally on the screen condition detection apparatus 102.

In various embodiments, the one or more trained models 120 may include a pixel degradation classification model for a subset of pixels (e.g., a portion of a screen) and/or a full screen of the mobile device 106 present in an image. In some embodiments, the one or more trained models 120 may include a screen condition detection model trained to determine a screen condition for a screen of the mobile device 106 present in an image. For example, the screen condition detection model may, in some embodiments, receive the output of the pixel degradation classification model to generate a screen condition indication. In some embodiments, the screen condition may be purely the output of the pixel degradation classification model. In some embodiments, the screen condition detection model may include one or more additional image-based analyses, such as a cosmetic defect detection of the surface of the screen. In some embodiments, the one or more trained models 120 may include a mobile device presence model trained to detect whether the mobile device 106 is present in an image. In some embodiments, the one or more trained models 120 may include a cropping model trained to optionally crop the image (e.g., image masking to eliminate portions of the image from the analysis, such as masking the non-screen portions of the image). In some embodiments, the one or more trained models 120 may include a device attribute model trained to determine one or more device attributes of the mobile device 106 based on one or more physical features of the mobile device 106 such as location of one or more lenses, device features, and/or other markings of the mobile device 106 in an image. In some embodiments the one or more device attributes may be determined via purely external visual analysis (e.g., using the device attribute model), using purely manual input, using purely electronic interrogation (e.g., via receiving wired or wireless signals from the mobile device indicating the one or more attributes), or a combination of any two or more of the foregoing. In some embodiments, the one or more trained models 120 may include a cover detection model trained to detect a cover on the mobile device 106 present in the image. In some embodiments, the one or more trained models 120 may include a mobile device front/rear identification model trained to determine whether an image reflects the front or rear of the mobile device 106. In some embodiments, the one or more trained models 120 may include a mobile device authenticity model trained to determine whether the image includes the mobile device 106 from which the image was captured. In some embodiments, the one or more trained models 120 may include an image quality model trained to determine whether the image includes sufficient quality (e.g., without blurriness, etc.) for a screen condition status process. In some embodiments, the one or more trained models 120 may additionally or alternatively include another type of model trained for providing an inference, classification, and/or prediction associated with one or more portions of one or more computer-implemented processes associated with providing a screen condition status associated with a screen of the mobile device 106. In various embodiments, two or more of the foregoing models may be executed independently or in conjunction with each other. For example, a device attribute detection model may be executed prior to executing a pixel degradation classification model and the mobile device attributes detected by the device attribute detection model may be used as inputs to the pixel degradation classification model.

In some embodiments, one or more of the foregoing models, including the pixel degradation classification model, may comprise one or more machine learning models and/or one or more layers of a machine learning model. A machine learning model may be initially fit or trained on a training dataset (e.g., a set of examples used to fit the parameters of the model). The model may be trained on the training dataset using supervised learning or unsupervised learning. The model is run with the training dataset and produces a result, which is then compared with a target, for each input vector in the training dataset. Based on the result of the comparison and the specific learning algorithm being used, the parameters of the model are adjusted. The model fitting may include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network).

A training dataset may be derived from the set of subject entities and historical data associated with the set of subject entities. For example, the subject entity characteristics and subject entity constituent data entity sets may be correlated with the subject entity performance metrics for a plurality of subject entities. In addition, data related to the constituent data entities, for example data stored in the constituent data entity metrics set, may be utilized in the training of a machine learning model.

In some embodiments, the machine learning model can be trained in real-time (e.g., online training) while in use. For example, a machine learning model may be trained based on reinforcement learning. A reinforcement learning may receive rewards or penalties based on actions taken or predictions. Reinforcement learning is based on rewarding desired behaviors and punishing undesired ones. A reinforcement learning model is configured over time to perform actions that lead to maximum reward. A reinforcement learning model includes an agent configured to take actions, receive rewards based on the actions, and update the machine learning model to maximize the received reward. In some embodiments, one or more subject entity performance metrics may be utilized as a reward parameter. In such an instance, the reinforcement learning model may determine inputs, to maximize the one or more subject entity performance metrics.

The machine learning models described above may make use of multiple ML engines, e.g., for analysis, recommendation generating, transformation, and other needs. The system may train different machine learning models for different needs and different machine learning-based engines. The system may generate new models (based on the gathered training data) and may evaluate their performance against the existing models. Training data may include any of the gathered information (e.g., subject entity characteristics, subject entity constituent data entity sets, subject entity performance metrics, constituent data entity metrics), as well as information on actions performed based on the various recommendations (e.g., updated target constituent data entity sets).

The machine learning models may be any suitable model for the task or activity implemented by each machine learning-based engine. For example, various machine learning models disclosed herein may comprise one or more forms of neural network. The term refers to the ability of systems to recognize patterns on the basis of existing algorithms and data sets to provide solution concepts. The more they are trained, the greater knowledge they develop. For example, the pixel degradation classification model discussed herein may utilize deep learning to train a high detail classification model for anomaly detection within a masked image of a mobile device screen. The model may output a confidence level associated with a likelihood of an anomaly (e.g., indicia of pixel degradation such as burn-in or bruising). Moreover, additional layers may be added to the model, such as to generate a heat map of the degraded areas of the screen and/or to generate a higher-order grading score (e.g., “major” degradation, “minor” degradation, or “no” degradation).

The underlying machine learning models may be learning models (supervised or unsupervised). As examples, such algorithms may be prediction (e.g., linear regression) algorithms, classification (e.g., decision trees, k-nearest neighbors) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative models (e.g., GANs).

Alternatively, machine learning models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders) to generate definitions and elements.

In various embodiments, the machine learning models may undergo a training or learning phase before they are released into a production, runtime, or classification phase or may begin operation with models from existing systems or models. During a training or learning phase, the machine learning models may be tuned to focus on specific variables, to reduce error margins, or to otherwise optimize their performance. The machine learning models may initially receive input from a wide variety of data, such as the gathered data described herein.

A classifier algorithm estimates a classification model from a set of training data. The classifier algorithm uses one or more classifiers and an associated algorithm to determine a probability or likelihood that a set of data belongs to another set of data. A decision tree model where a target variable can take a discrete set of values is called a classification tree (e.g., and therefore can be considered a classifier or classification algorithm).

A supervised model or predictive model is an estimate of a mathematical relationship in which the value of a dependent variable is calculated from the values of one or more independent variables. The functional form of the relationship is determined by the specific type (e.g., decision tree, Generalized Linear Model, gradient boosted trees) of supervised model. Individual numeric components of the mathematical relationship are estimated based on a set of training data. The set of functional forms and numerical estimates a specific type of supervised model can represent is called its “hypothesis space”.

In some embodiments, the connection 140 may be associated with an electrical connector such as a USB connector, a USB-C® connector, a USB Micro-B connector, a lightning® connector, and/or similar connectors. In some embodiments, the connection 140 may be associated with a communications network. The communications network may be configurable to be embodied in any of a myriad of network configurations. In some embodiments, the communications network embodies a public network (e.g., the Internet). In some embodiments, the communications network embodies a private network (e.g., an internal, localized, or closed-off network between particular devices). In some other embodiments, the communications network embodies a hybrid network (e.g., a network enabling internal communication between particular connected devices and external communication with other devices). The communications network in some embodiments includes one or more base station(s), relay(s), router(s), switch(es), cell tower(s), communications cable(s) and/or associated routing station(s), and/or the like. In some embodiments, the communications network includes one or more computing device(s) controlled by individual entities (e.g., an entity-owner router and/or modem) and/or one or more external utility devices (e.g., Internet service provider communication tower(s) and/or other device(s)).

Non-limiting examples of network configuration(s) for the connection 140 include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network(s), the various embodiments are not limited to this particular architecture. In other embodiments, one or more computing entities share one or more components, hardware, and/or the like, or otherwise are embodied by a single computing device such that connection(s) between the computing entities are altered and/or rendered unnecessary. Alternatively or additionally still, in some embodiments the communications network enables communication to one or more other computing device(s) not depicted, for example client device(s) for accessing functionality of any of the subsystems therein via native and/or web-based application(s), and/or the like.

The various system components shown and described herein may be part of a single apparatus, assembly, or system, or may be separate apparatuses, assemblies, or systems. The various physical devices according to the present disclosure (e.g., the robot arm 110, image capture device(s), conveyors, etc.) may comprise separate, local controllers (e.g., programmable logic controllers) that may connect with and be coordinated by one or more additional computing devices (e.g., the screen condition detection apparatus). In some embodiments, the functions of the foregoing apparatuses, assemblies, and systems may be coordinated in one or more layers of instruction spread across one or more computing devices (e.g., including but not limited to the foregoing controllers, screen condition detection apparatus, or the like).

### Example Apparatus

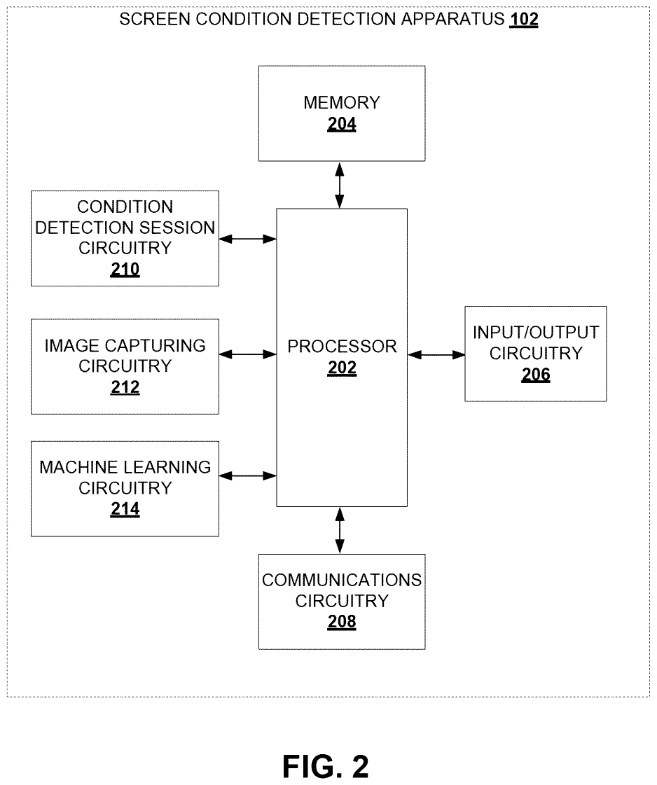

FIG. 2 illustrates a block diagram of an example apparatus that may be specially configured in accordance with at least one example embodiment of the present disclosure. Specifically, FIG. 2 illustrates an example screen condition detection apparatus 102 (“apparatus 102”) specially configured in accordance with at least one example embodiment of the present disclosure. In some embodiments, the screen condition detection apparatus 102, and/or a portion thereof, is embodied by one or more system(s), device(s), and/or the like, such as the screen condition detection apparatus 102 as depicted and described in FIG. 2. The screen condition detection apparatus 102 includes processor 202, memory 204, input/output circuitry 206, communications circuitry 208, condition detection session circuitry 210, image capturing circuitry 212, and/or machine learning circuitry 214. In some embodiments, the screen condition detection apparatus 102 is configured, using one or more of the sets of circuitry 202, 204, 206, 208, 210, 212, and/or 214, to execute and perform one or more of the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, modeling, and/or similar terms used herein interchangeably. In one embodiment, these functions, operations, and/or processes may be performed on data, content, information, and/or similar terms used herein interchangeably. In this regard, the screen condition detection apparatus 102 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the screen condition detection apparatus 102 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the screen condition detection apparatus 102. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the screen condition detection apparatus 102 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the screen condition detection apparatus 102, and/or one or more remote or “cloud” processor(s) external to the screen condition detection apparatus 102.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. In some embodiments, the processor 202 includes or is embodied by a CPU, microprocessor, and/or the like that executes computer-coded instructions, for example stored via the non-transitory memory 204.

In some embodiments, the screen condition detection apparatus 102 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user. In some embodiments, the input/output circuitry 206 includes hardware, software, firmware, and/or a combination thereof, that facilitates simultaneously display of particular data via a plurality of different devices.

In some embodiments, the screen condition detection apparatus 102 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the screen condition detection apparatus 102. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from a client device, capture device, and/or other external computing device in communication with the screen condition detection apparatus 102.

In some embodiments, the screen condition detection apparatus 102 includes condition detection session circuitry 210. The condition detection session circuitry 210 includes hardware, software, firmware, and/or a combination thereof, that supports various functionality associated with managing a screen condition status session for providing a screen condition status associated with a screen of the mobile device 106. In some embodiments, the condition detection session circuitry 210 includes hardware, software, firmware, and/or a combination thereof, that adjusts one or more display settings for a screen of the mobile device 106 based at least in part on one or more mobile device attributes associated with the mobile device 106 to provide a test-enabled version of the screen. In some embodiments, the condition detection session circuitry 210 additionally or alternatively includes hardware, software, firmware, and/or a combination thereof, that determines a screen condition for the screen based at least in part on a pixel degradation classification for the screen as provided by at least one trained model of the one or more trained models 120. For example, the condition detection session circuitry 210 may additionally or alternatively include hardware, software, firmware, and/or a combination thereof, that determines a screen condition for the screen based on a pixel degradation classification for respective pixels of the screen as provided by at least one trained model of the one or more trained models 120. In some embodiments, the condition detection session circuitry 210 additionally or alternatively includes hardware, software, firmware, and/or a combination thereof, that adjusts one or more settings of the one or more image capture devices 130 based on the one or more mobile device attributes to provide the test-enabled version of the screen. The one or more settings of the one or more image capture devices 130 may include an exposure setting, a frame rate setting, and/or one or more other types of settings to optimally configure the one or more image capture devices 130 for capturing one or more images of the mobile device 106.

In some embodiments, the condition detection session circuitry 210 additionally or alternatively includes hardware, software, firmware, and/or a combination thereof, that captures a first image of the test-enabled version of the screen via the one or more image capture devices 130. In some embodiments, the condition detection session circuitry 210 additionally or alternatively includes hardware, software, firmware, and/or a combination thereof, that analyzes the first image to determine one or more histogram attributes associated with the first image. For example, the condition detection session circuitry 210 may be configured to receive a first image of the mobile device and generate at least one histogram attribute comprising a histogram value associated with the image. The histogram value may serve as an input to a calibration step whereby an image capture device(s) is calibrated. For example, an exposure setting associated with one or more image capture device(s) may be calibrated to a standard value such that the pixel degradation classification model receives a standardized input regardless of the screen and/or image capture device being used. In some embodiments, the condition detection session circuitry 210 additionally or alternatively includes hardware, software, firmware, and/or a combination thereof, that calibrates one or more settings of the one or more image capture devices 130 based on the one or more histogram attributes to provide a calibrated version of the one or more image capture devices 130 for the test-enabled version of the screen. In some embodiments, the condition detection session circuitry 210 additionally or alternatively includes hardware, software, firmware, and/or a combination thereof, that captures a second image of the test-enabled version of the screen via the calibrated version of the one or more image capture devices 130. In some embodiments, at least one trained model of the one or more trained models 120 may be applied to the second image to determine the pixel degradation classification for the screen.

In some embodiments, the condition detection session circuitry 210 additionally or alternatively includes hardware, software, firmware, and/or a combination thereof, that controls the robot arm 110 to enable a connection between a port of the mobile device 106 and an electrical connector of the mobile device engagement system 104. In some embodiments, responsive to the port of the mobile device 106 being connected to the electrical connector of the mobile device engagement system 104, the condition detection session circuitry 210 additionally or alternatively includes hardware, software, firmware, and/or a combination thereof, that initiates transmission of one or more signals between the mobile device engagement system 104 and the mobile device 106 to cause adjustment of the one or more display settings for the screen of the mobile device 106.

Additionally or alternatively, in some embodiments, the condition detection session circuitry 210 includes hardware, software, firmware, and/or a combination thereof, that enables access to one or more API(s), FTP connection(s), HTTP connection(s), SFTP connection(s), and/or the like to securely monitor, acquire, receive, retrieve, transmit and/or otherwise identify electronic data from one or more systems (e.g., the mobile device 106) external from the screen condition detection apparatus 102. In some embodiments, the condition detection session circuitry 210 includes a separate processor, specially configured field programmable gate array (FPGA), or a specially programmed application specific integrated circuit (ASIC).

In some embodiments, the screen condition detection apparatus 102 includes image capturing circuitry 212. The image capturing circuitry 212 includes hardware, software, firmware, and/or a combination thereof, that supports various functionality associated with capturing at least one image of a screen of the mobile device 106 (e.g., a test-enabled version of the screen) to facilitate determining a screen condition status associated with the screen of the mobile device 106. In some embodiments, the image capturing circuitry 212 additionally or alternatively includes hardware, software, firmware, and/or a combination thereof, that captures one or more images of the mobile device 106 via the one or more image capture devices 130 and analyzes the one or more images to determine the one or more mobile device attributes associated with the mobile device 106 (e.g., to inform one or more downstream processes, such as an electrical connector and/or a display setting procedure). In some embodiments, the image capturing circuitry 212 includes a separate processor, specially configured FPGA, or a specially programmed ASIC.

In some embodiments, the screen condition detection apparatus 102 includes machine learning circuitry 214. The machine learning circuitry 214 includes hardware, software, firmware, and/or a combination thereof, that supports various functionality associated with the one or more trained models 120. For example, in some embodiments, the machine learning circuitry 214 includes hardware, software, firmware, and/or a combination thereof, that analyzes at least one image of the mobile device 106 by utilizing the one or more trained models 120 to determine a screen condition associated with a screen of the mobile device 106. In some embodiments, the machine learning circuitry 214 additionally or alternatively includes hardware, software, firmware, and/or a combination thereof, that applies at least one trained model of the one or more trained models 120 to the at least one image to determine a pixel degradation classification for the screen of the mobile device 106. For example, the machine learning circuitry 214 may additionally or alternatively includes hardware, software, firmware, and/or a combination thereof, that applies a neural network model to the at least one image to determine a pixel degradation classification for the screen of the mobile device 106. In some embodiments, the machine learning circuitry 214 additionally or alternatively includes hardware, software, firmware, and/or a combination thereof, that selects the at least one trained model of the one or more trained models 120 (e.g., the neural network model) from a plurality of trained models (e.g., a plurality of neural network models), for example, based on the one or more mobile device attributes associated with the mobile device 106. In some embodiments, the at least one trained model of the one or more trained models 120 (e.g., the neural network model) is trained based on an image dataset associated with desirable pixel quality for mobile devices. In some embodiments, the at least one trained model of the one or more trained models 120 (e.g., the neural network model) is additionally or alternatively trained based on a first image dataset associated with pixel degradation and a second image dataset associated with desirable pixel quality. In some embodiments, the machine learning circuitry 214 additionally or alternatively includes hardware, software, firmware, and/or a combination thereof, that retrains and/or initiates retraining of the at least one trained model of the one or more trained models 120 (e.g., the neural network model) based on the at least one image. In some embodiments, the machine learning circuitry 214 additionally or alternatively includes hardware, software, firmware, and/or a combination thereof, that retrains and/or initiates the retraining of the at least one trained model of the one or more trained models 120 (e.g., the neural network model) in response to a determination that the screen condition satisfies defined screen condition criteria.

In some embodiments, the at least one trained model of the one or more trained models 120 that determines a pixel degradation classification for the screen of the mobile device 106 may be a neural network model. A neural network model may be a data entity that describes parameters, hyper-parameters, and/or defined operations configured, trained, and/or the like to generate an output for a predictive task and/or a classification task using one or more neural network layers of a neural network. For example, a neural network model may include one or more neural network layers that depend on trained parameters, weights, coefficients, and/or the like. Additionally, a neural network model may include a set of neural network tokens configured for a predictive task and/or a classification task related to determining pixel degradation associated with the screen of the mobile device 106. In some embodiments, a neural network model may be configured as a deep learning model, a convolutional neural network (CNN) model, an artificial neural network (ANN) model, a simulated neural network (SNN) model, and/or another type of neural network model.

In some embodiments, the machine learning circuitry 214 includes a separate processor, specially configured FPGA, or a specially programmed ASIC. In some embodiments, the machine learning circuitry 214 includes hardware, software, firmware, and/or a combination thereof, that enables local execution of the one or more trained models 120 via the screen condition detection apparatus 102. In other embodiments, the machine learning circuitry 214 includes hardware, software, firmware, and/or a combination thereof, that enables remote execution of the one or more trained models 120 via a network. As such, in some embodiments, the machine learning circuitry 214 can be circuitry capable of executing a trained model with or without utilizing dedicated and/or pre-installed machine learning hardware.

Additionally or alternatively, in some embodiments, two or more of the sets of circuitries 202-214 are combinable. Alternatively or additionally, in some embodiments, one or more of the sets of circuitry perform some or all of the functionality described associated with another component. For example, in some embodiments, two or more of the sets of circuitry 202-214 are combined into a single module embodied in hardware, software, firmware, and/or a combination thereof. Similarly, in some embodiments, one or more of the sets of circuitry, for example the condition detection session circuitry 210, image capturing circuitry 212, and/or machine learning circuitry 214, is/are combined with the processor 202, such that the processor 202 performs one or more of the operations described above with respect to each of these sets of circuitry 210-214.

### Example Mobile Device Engagement System

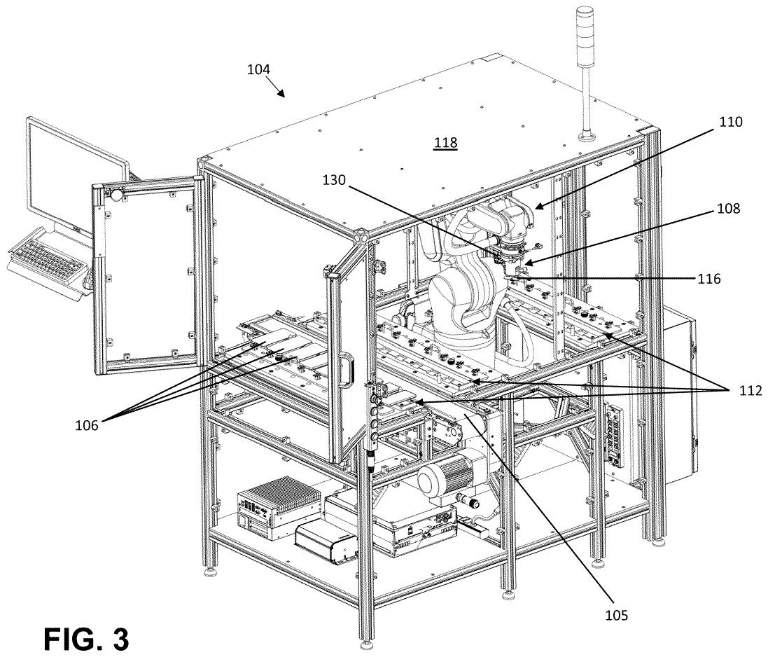

FIG. 3 illustrates various aspects of a mobile device engagement system 104 in accordance with various embodiments of the present disclosure.

In various embodiments, the mobile device engagement system 104 includes a conveyor belt 105. The conveyor belt 105 may be configured to carry the mobile device(s) 106 from a first location to a proximity of a robot arm 110. The first location may refer to a collection location, storage location, sorting location, etc., of the mobile device 106. For example, the first location may be any location inside or outside the reach of the robot arm 110 and the proximity of the robot arm 110 may refer to the area within the reach of the robot arm 110. In various embodiments, the mobile device engagement system 104 is placed within a housing 118. The first location may be any location outside the housing 118.

In various embodiments, the housing 118 may be configured to enclose one or more components of the mobile device engagement system 104. The housing 118 may be configured to protect various components of the mobile device engagement system 104. The housing 118 may be closed, open, or partially open. The housing 118 may be transparent or include transparent sections.

The mobile device engagement system 104 may include the robot arm 110 fully or partially placed in the housing 118. In various embodiments, the robot arm 110 may be a multi-axis robot arm, for example a two-, three-, four-, five-, or six-axis robot arm. In some examples, the robot arm may include a higher number of rotation axes. The robot arm 110 may comprise the end effector 108.

In various embodiments, the end effector 108 may be configured to engage and facilitate positioning of the mobile device 106. The end effector 108 may be mechanically coupled to an end of the robot arm 110 and include a mechanism 116 (such as suction device, a gripper, a grabbing tool, and/or other similar means) to engage the mobile device 106. After the end effector 108 engages the mobile device 106, the robot arm 110 may move the mobile device 106 to various other positions and/or locations. The robot arm 110, using the end effector 108, may also orient the mobile device 106 in various directions, for example in any direction in the three-dimensional spherical coordinates.

In various embodiments, the robot arm 110 is configured to lift the mobile device 106 from the conveyor belt 105, and place the mobile device 106 on the conveyor belt or a second conveyor belt after a subsequent mode of operation of the mobile device (such as a software install, charging, charge level testing, data wiping, running the mobile device in a debug mode, etc.) is executed.

In various embodiments, the conveyor belt 105 is configured to carry the mobile device 106 to a second location. The second location may refer to another collection location, storage location, sorting location, or a packing location, etc., of the mobile device 106. In various embodiments, the second location may be out of the reach of the robot arm 110. In various embodiments, the second location may be any location outside the housing 118.

In various embodiments, the mobile device engagement system 104 is configured to engage the mobile device 106 with an electrical connector on a station of a plurality of stations for example stations 112. The plurality of stations may be arranged in one or more banks of stations inside the housing 118. For example, as shown in FIG. 3, each bank of stations may comprise a plurality of stations arranged in a row. In an example, the stations are arranged in one or more rows on each side of the conveyor belt 105. In some examples, the stations are arranged in one or more rows on each side of the robot arm 110. For example, three rows of stations 112 may be implemented with two on a first side of the robot arm 110 and a third on a second side of the robot arm. Each of the stations 112 may be within reach of the robot arm 110. For example, in the depicted embodiment of FIG. 3, the mobile device engagement system 104 includes three banks (e.g., rows) having nine stations 112 each. However, the plurality of stations may be arranged in any other fashions and not limited to the examples explicitly described. Various additional examples of the operation of a robot arm, methods for coupling a mobile device with an electrical connector, and various downstream electronic processes performed on the mobile device via the electrical connection are shown and described in U.S. application Ser. No. 18/990,549, filed Dec. 20, 2024, and entitled “Robot Enabled Mobile Device Manipulation System, Method, And Apparatus”, which application is incorporated by reference herein in its entirety. In various embodiments, multiple mobile device engagement systems 104 may be organized in series and/or in parallel within a larger mobile device processing environment.

In various embodiments, the mobile device engagement system 104 may include the one or more image capture devices 130 configured to capture one or more images of a screen the mobile device 106. For example, with reference to FIG. 3, an image capture device 130 is integrated into an upper end of the end effector 108 above and to one side of the mechanism 116 (e.g., a set of suction heads). In the depicted embodiment, the image capture device 130 is oriented distally (e.g., downward relative to the orientation of the arm in the depicted position) along a longitudinal, grabbing axis of the end effector. In various embodiments, the mobile device engagement system 104 may include or be electronically coupled to the screen condition detection apparatus 102 for various control and analysis functions in accordance with one or more embodiments described herein.

In various embodiments, the screen condition detection apparatus 102 is electronically coupled to the one or more image capture devices 130 (e.g., locally connected from within or proximate the housing 118 using a wired and/or wireless connection and/or remotely such as via a server using a wired and/or wireless connection). The screen condition detection apparatus 102 may instruct (e.g., directly or via indirect communication to a controller of the robot arm 110 and/or mobile device engagement system 104) the one or more image capture devices 130 to capture at least one image of the screen of the mobile device 106.

In coordination with the robot arm 110 (e.g., directly or indirectly), the screen condition detection apparatus 102 and/or the mobile device engagement system 104 may instruct the robot arm 110 (via control signals to a control device associated with the robot arm) to position the image capture device(s) 130 in a position over the mobile device(s) 106 to image the screen. For example, in some embodiments, the robot arm 110 may be configured to position the end effector 108 and image capture device 130 directly vertically over each mobile device (e.g., such that the image capture device is directly facing the screen perpendicular to a plane of the screen) to capture one or more images of the mobile device. For example, in some embodiments, the robot arm 110 and image capture device 130 may be configured to capture one or more images of each mobile device immediately after depositing each mobile device in the respective stations and connecting the mobile device with the electrical connector of the mobile device engagement system 104 stations 112. In some other embodiments, the robot arm 110 may be directed back to each respective mobile device for image capture. In some embodiments, the robot arm 110 and image capture device 130 may be configured to capture one or more images of each mobile device after one or more various software processes are run on the mobile devices (e.g., software and/or inputs received via the electrical connectors of the respective stations, such as from the screen condition detection apparatus 102 or another computing device).

In various embodiments, the screen condition detection apparatus 102 may adjust one or more display settings for a screen of the mobile device 106 based at on one or more mobile device attributes associated with the mobile device 106 to provide a test-enabled version of the screen. For example, the screen condition detection apparatus 102 may communicate with each respective mobile device 106 via the electrical connectors at each station 112 and transmit instructions configured to cause the mobile devices to adjust one or more display settings associated with the screen. In some embodiments, the screen condition detection apparatus 102 may push a software application to the mobile device 106 or instruct the mobile device to download a software application that may control one or more display settings. In some embodiments, the screen condition detection apparatus 102 may directly control the mobile device (e.g., via simulated peripherals, such as keystrokes and/or mouse movements, transmitted over the electrical connection using device IDs associated with known peripherals) to manipulate one or more options (e.g., running apps, modifying menu options, etc.) on the mobile device to modify the display settings. In some embodiments, the one or more image capture devices 130 (e.g., including an image capture device 130 coupled with the robot arm 110 or another image capture device having a field of view of the respective mobile device being manipulated, whether such image capture device is stationary, such as mounted to the housing 118, or movable, such as mounted to another robot arm) to visualize the screen during the display setting adjustment and via a trained model (e.g., computer vision model trained to recognize respective screens and menu items of the mobile device interface) direct the modification of the display settings to result in the test-enabled version of the screen.

The screen condition detection apparatus 102 may instruct the one or more image capture devices 130 to capture at least one image of the test-enabled version of the screen. In various embodiments, the screen condition detection apparatus 102 may determine (e.g., via processor 202 shown in FIG. 2) a position, dimensions, and/or orientation associated with the mobile device 106 using one or more images associated with the mobile device. In various embodiments, the screen condition detection apparatus 102 may control the robot arm 110 to engage the mobile device 106 with the end effector 108 using the position associated with the mobile device 106. The screen condition detection apparatus 102 may be configured to direct the robot arm 110 to the image capture location (e.g., a predetermined location over the respective mobile device for each image capture process as described herein) to obtain consistent perspectives of each mobile device for modeling. In some embodiments, the screen condition detection apparatus 102 may additionally or alternatively be configured to pre-process the images for input to the classification models to obtain a transformed image from a predetermined virtual perspective.

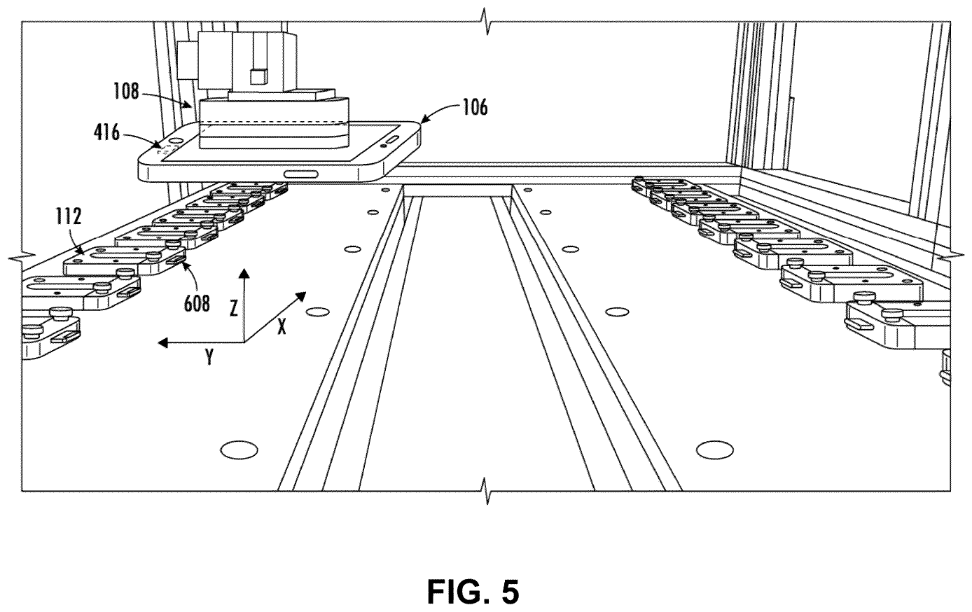

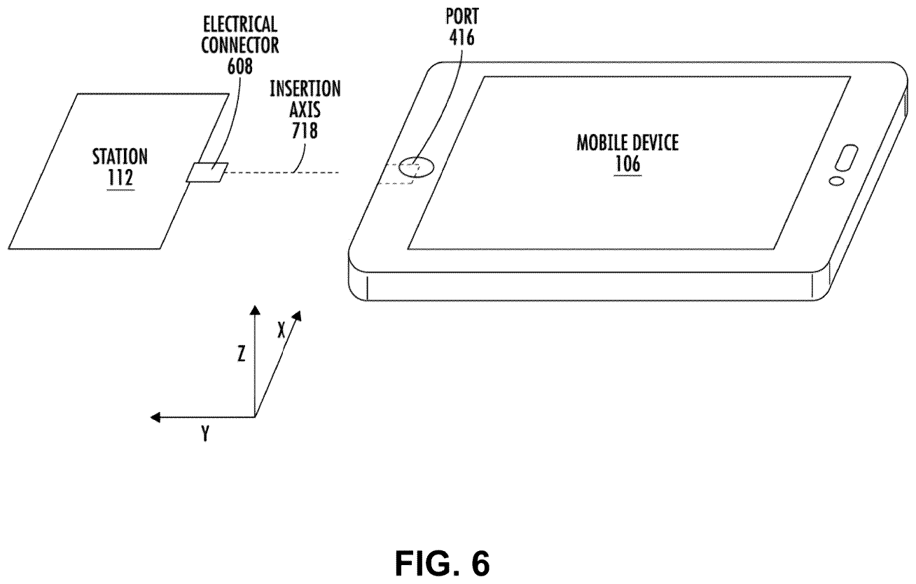

In various embodiments, the screen condition detection apparatus 102 may instruct the one or more imaging device to capture one or more images of the mobile device 106 to enable determination of a position of a port of the mobile device 106 relative to a position of an electrical connector in the one or more stations. In some embodiments, the screen condition detection apparatus 102 may be configured to control the robot arm to position the mobile device 106 along an insertion axis defined by the electrical connector with the port of the mobile device 106 aligned with the insertion axis, such that the port faces the electrical connector. In some embodiments, the screen condition detection apparatus 102 may be configured to control the robot arm to translate the mobile device along the insertion axis to electronically couple the mobile device 106 with the electrical connector. Example arrangements of the electrical connectors, the insertion axis, alignment of the mobile device 106 with the insertion axis, and electronically coupling the mobile device with the electrical connector are further illustrated and described with reference to FIG. 5 and FIG. 6 herein.

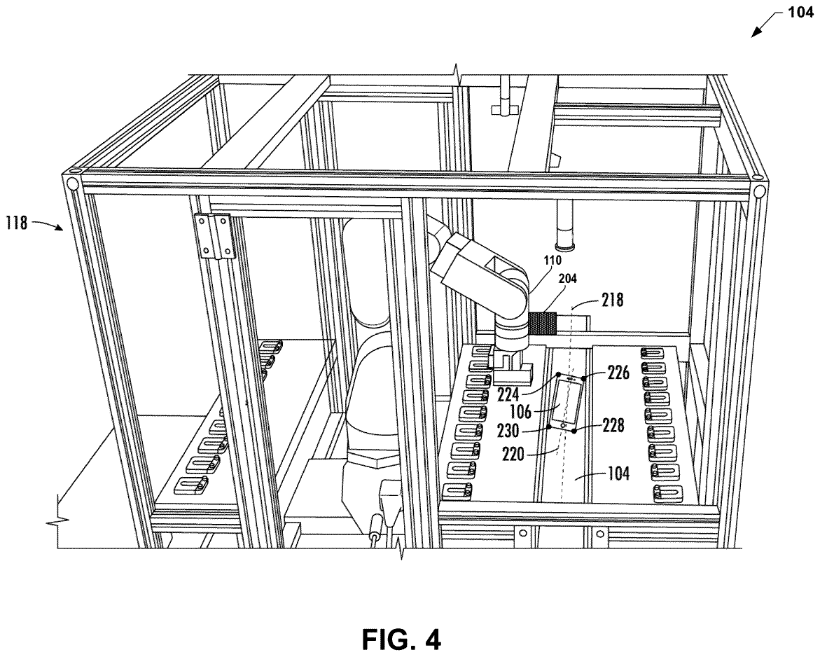

FIG. 4 illustrates various aspects of the mobile device engagement system 104 in accordance with various embodiments of the present disclosure. In the embodiment of FIG. 4, the assembly of the mobile device engagement system 104 has been simplified for illustration, and it should be understood that the features and functionalities shown and described with respect to the embodiment of FIG. 4 are also applicable for the embodiment shown and described in FIG. 3.

In various embodiments, the mobile device engagement system 104 includes an image capture device 130 (e.g., image capture device 130 is shown on the opposite side of the arm 110 relative to the image capture device of FIG. 3, and the devices are otherwise the same) of the one or more image capture devices 130. The image capture device 130 may be configured to capture at least one image of a screen (e.g., a test-enabled version of the screen in some embodiments) of the mobile device 106. In various embodiments, the image capture device 130 may be attached to the robot arm 110 to enable optimal capture of the at least one image of a screen (e.g., a test-enabled version of the screen) of the mobile device 106.

In various embodiments, the screen condition detection apparatus 102 may determine a two-or three-dimensional position, which position may include an orientation (e.g., an angle of rotation), and/or the width and length (or other dimension(s)) of the mobile device 106 to facilitate engaging the mobile device with the end effector 108. For example, the screen condition detection apparatus 102 may determine corner coordinates of the mobile device 106, for example, first corner 224, second corner 226, third corner 228, and/or fourth corner 230. In various embodiments, the screen condition detection apparatus 102 may determine the orientation of the mobile device 106 by determining an angle between an axis 220 that passes through a middle of the mobile device 106 and axis 218 that passes through a middle of the conveyor belt 105. In some embodiments, the image capture device 130 coupled with the robot arm 110 may be used for this position determination operation. In some embodiments, another image capture device (e.g., a stationary image capture device mounted within the housing 118) may be used.

In various embodiments, using the corner coordinates and/or orientation of the mobile device 106, the screen condition detection apparatus 102 may determine the position and/or dimensions of the mobile device 106 and use the position and/or dimensions information to instruct the robot arm 110 to move the end effector 108 to a corresponding position and/or to be orientated at a corresponding orientation to engage the mobile device 106. For example, when the end effector 108 includes a gripper, the end effector 108 may engage the mobile device 106 at its corner points and/or corner edges. In some embodiments, the end effector 108 may have asymmetrical dimensions (e.g., a suction gripper that is longer along one axis than another) and the dimensions of the end effector 108 may be aligned with the long and short dimensions of the mobile device 106.

In various embodiments, using the corner coordinates and/or orientation of the mobile device 106, the screen condition detection apparatus 102 may determine a geometric center of at least one surface of the mobile device 106. Additionally, the screen condition detection apparatus 102 may instruct the robot arm 110 to move the end effector 108 to the proximity of the geometric center of at least one surface of the mobile device 106 to engage the mobile device 106. For example, when the end effector 108 includes a suction tool, the end effector 108 may engage the mobile device 106 at and/or at a proximity of the geometric center of at least one surface of the mobile device 106.

In various embodiments, the screen condition detection apparatus 102 may determine the position, dimensions, and/or geometric center of at least one surface of the mobile device 106 using various other image analysis, recognition, and/or calculations on one or captured images of the mobile device via the image capture device 130.

FIG. 5 illustrates various aspects of a mobile device engagement system 104 in accordance with various embodiments of the present disclosure.

In various embodiments, the screen condition detection apparatus 102 may control the robot arm 110 and/or initiate programmed movement to the identified station 112 of the mobile device engagement system 104 to facilitate the screen condition detection session associated with the screen condition detection apparatus 102. During the programmed movement, the robot arm 110 may move the mobile device 106 to a proximity of a corresponding station (e.g., station 112) having an available electrical connector (e.g., electrical connector 608) of the same type as the port 416 of the mobile device 106.

In various embodiments, after the robot arm 110 moves the mobile device 106 to the proximity of the corresponding station, the robot arm 110 adjusts a position of the mobile device 106 to align the port 416 with the electrical connector 608 of the corresponding station. For example, the robot arm may adjust a position of the mobile device in the X, Z plane to align the port 416 with an insertion axis (as further described below with reference to FIG. 6).

In various embodiments, when the port 416 of the mobile device 106 is aligned with the corresponding electrical connector of the respective station 112, the robot arm 110 translates the mobile device 106 towards the electrical connector 608. In various embodiments, one or more computing device uses a force measured using a force sensor to determine how far to translate the mobile device 106 toward the electrical connector 608.

In various embodiments, the force sensor may be mechanically coupled to the robot arm 110. For example, a force sensor may be mechanically coupled to the robot arm 110 such that the force sensor can measure a force applied to the mobile device 106 when translating the mobile device 106 toward the corresponding electrical connector 608. In some embodiments, the force sensor may be a force torque sensor installed on the robotic arm 110 between two or more components of the robot arm 110.

In various embodiments, the force sensor may be mechanically coupled to the corresponding station 112. In various embodiments, any or all of the stations of the mobile device engagement system 104 may include a force sensor, so long as the force between the mobile device 106 and the station (or some portion thereof or feature attached thereto) is determined.

Adjusting a position of the mobile device 106 and electronic coupling of the port 416 of the mobile device 106 with a corresponding station (e.g., station 112) is further illustrated in FIG. 6.

Referring to FIG. 6, the robot arm aligns the port 416 with the insertion axis 718 such that the port 416 is aligned with the electrical connector 608 and can physically and electronically couple when the mobile device 106 is translated to the station 112 along the insertion axis 718. For example, mobile devices using a USB-C port may engage with a corresponding USB-C plug of the station to establish an electronic connection with a charge source and/or one or more computing devices. In some embodiments, the robot arm 110 may move the mobile device 106 from the imaging location to an aligned location with the insertion axis 718 via a series of rotational and/or translational movements.

As previously described, in various embodiments, the mobile device engagement system 104 comprises a force sensor mounted on the one of the robot arm 110, end effector 108, or station 112. The force sensor may be configured to determine a force applied to the electrical connector 608 and/or the station 112 by the mobile device 106, or the force applied to the mobile device 106 by the electrical connector 608 and/or the station 112 during translation of the mobile device by the robot arm 110.

In various embodiments, the screen condition detection apparatus 102 is configured to instruct the robot arm 110 to stop translating the mobile device 106 along the insertion axis 718 toward the electrical connector 608 when the force determined by the force sensor is higher than a force threshold, which threshold may indicate that the station 112 and/or electrical connector 608 is resisting the mobile device 106 to such a degree that the connector must be sufficiently inserted into the port and/or the electrical connector and port are misaligned and the connector is impinging on another portion of the mobile device 106.

In various embodiments, the screen condition detection apparatus 102 is further configured to determine an electronic coupling (e.g., data connection) to the mobile device 106 via the electrical connector. The screen condition detection apparatus 102 may determine an electronic connectivity issue between the port of the mobile device 106 and the electrical connector in an instance in which the force is higher than the force threshold and an absence of the electronic coupling (e.g., data connection) with the mobile device 106 via the electrical connector 608 is determined.

In various embodiments, when the electronic connectivity issue is determined, the screen condition detection apparatus 102 is configured to instruct the robot arm 110 to move the mobile device 106 away from the electrical connector 608, reposition the mobile device 106 along the insertion axis 718 of the electrical connector 608, and translate the mobile device 106 along the insertion axis 718 to electronically couple with the electrical connector 608.

In various embodiments, responsive to the port 416 of the mobile device 106 being connected to the electrical connector 608 of the mobile device engagement system 104, the screen condition detection apparatus 102 may initiate transmission of one or more signals between the mobile device engagement system 104 and the mobile device 106 (e.g., via the connection 140) to cause adjustment of the one or more display settings for the screen of the mobile device 106 and/or to capture at least one image of the test-enabled version of the screen via the image capture device 130.

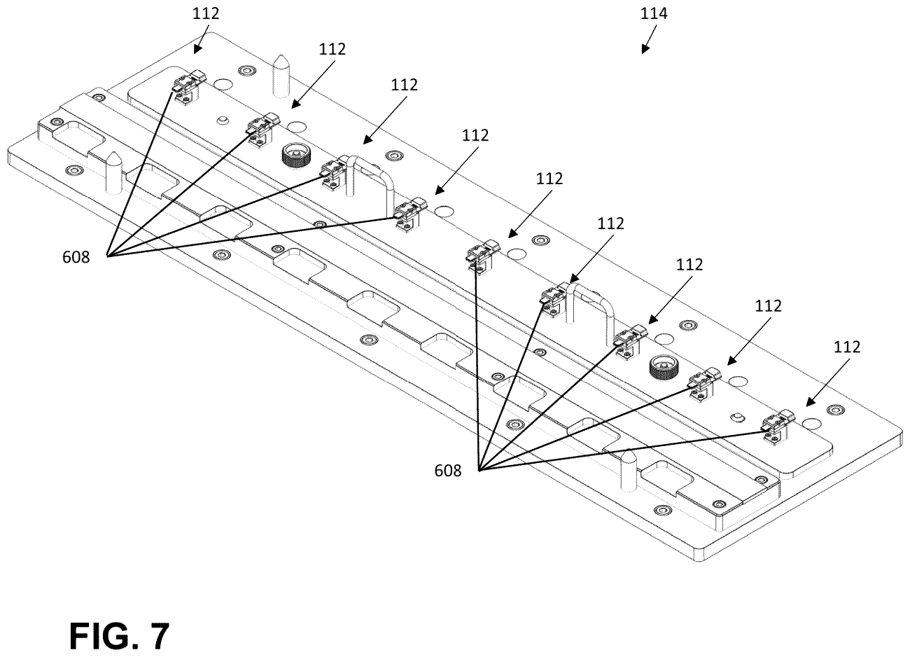

Turning to FIG. 7, an example bank 114 of stations 112 is illustrated. The bank 114 may comprise a plate having a plurality of electrical connectors 608 thereon, with each electrical connector defining a respective station 112. In some embodiments, the banks 114 may be interchangeable to retool the mobile device engagement system 104 for different sized mobile devices (e.g., by spacing the electrical connectors at different intervals, such as to configure the system for tablets versus mobile phones or to configured the system for larger and smaller mobile phones) and/or different configurations of mobile devices (e.g., different connectors depending on the particular mobile device. For example, the depicted bank 114 is configured to receive nine mobile devices of approximately smartphone size using LIGHTNING type electrical connectors 608. The mobile device engagement system 104 may be reconfigured by, for example, replacing one or more of the banks 114 with any differently configured banks. As a larger system, multiple mobile device engagement systems 104 may be used with different respectively configured banks to develop parallel workflows for different types of mobile devices. The banks 114 may be exchanged, for example, by removing and reinstalling a plurality of fasteners (e.g., screws).

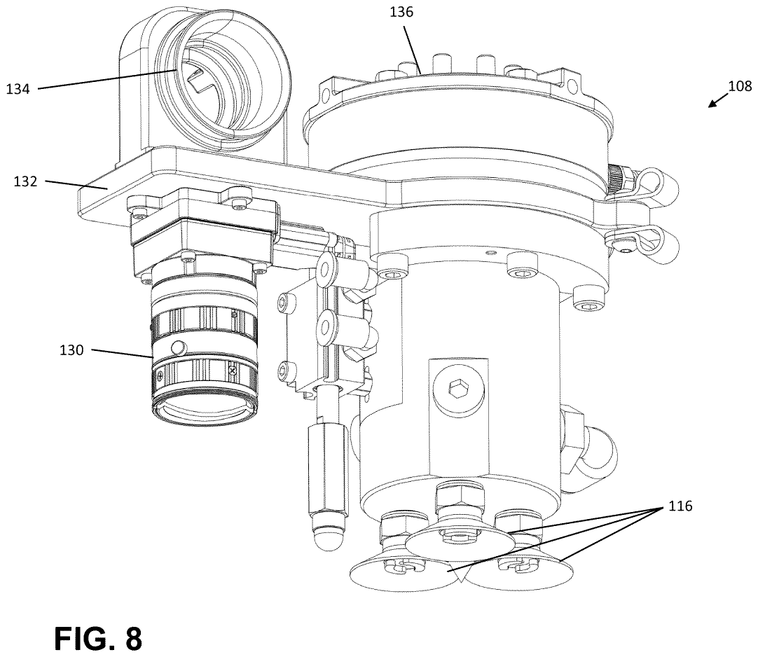

Referring to FIG. 8, a detailed view of an end effector 108 is shown according to various embodiments of the present disclosure. In the depicted embodiment, the end effector 108 includes a mechanism 116 comprising a plurality of suction heads configured to engage and hold mobile devices for movement by the robot arm. The end effector 108 is further depicted with an image capture device 130 disposed to one side of the mechanism 116 and oriented in the same direction as the suction heads (e.g., configured to face the mobile device). For example, during operation, the robot arm may move between a first position, in which the suction heads are engaged with the mobile device for movement, and a second position, in which the camera is disposed directly over the mobile device for imaging. In some embodiments, the end effector 108 or a portion thereof (e.g., the suction heads or other mechanism 116) may be at least partially within the field of view of the image capture device 130. In various embodiments, the image capture device may face one or more other directions and/or may be engaged with various other parts of the robot arm (or coupled with a second robot arm, such as a dedicated imaging robot arm). In some embodiments, multiple image capture devices may be used in any one or more of the foregoing locations. The depicted image capture device 130 is attached to a flange 132 of the end effector and the end effector comprises an electrical coupling 134 for allowing one or more connectors associated with the image capture device to electrically connect the image capture device with one or more computing devices (e.g., the screen condition detection apparatus 102). In the depicted embodiment, the end effector 108 comprises a robot arm coupling end 136 configured to engage the remaining articulating body of the robot arm for manipulation thereby.

### Example Screen Condition Detection

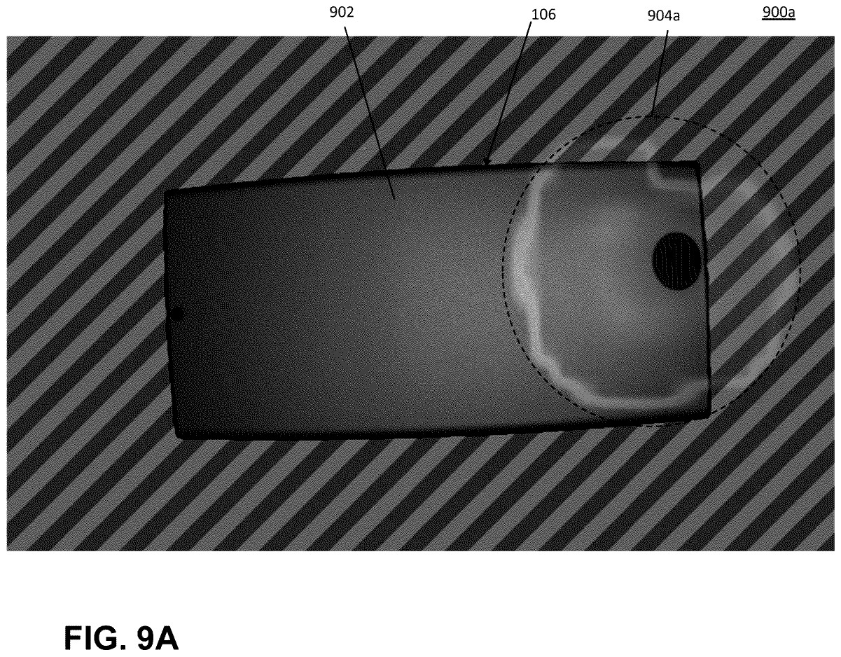

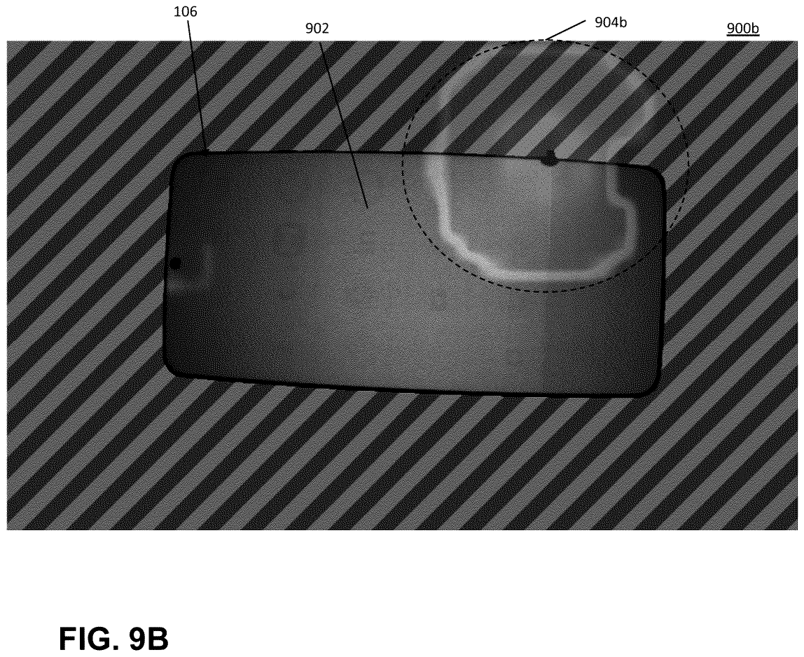

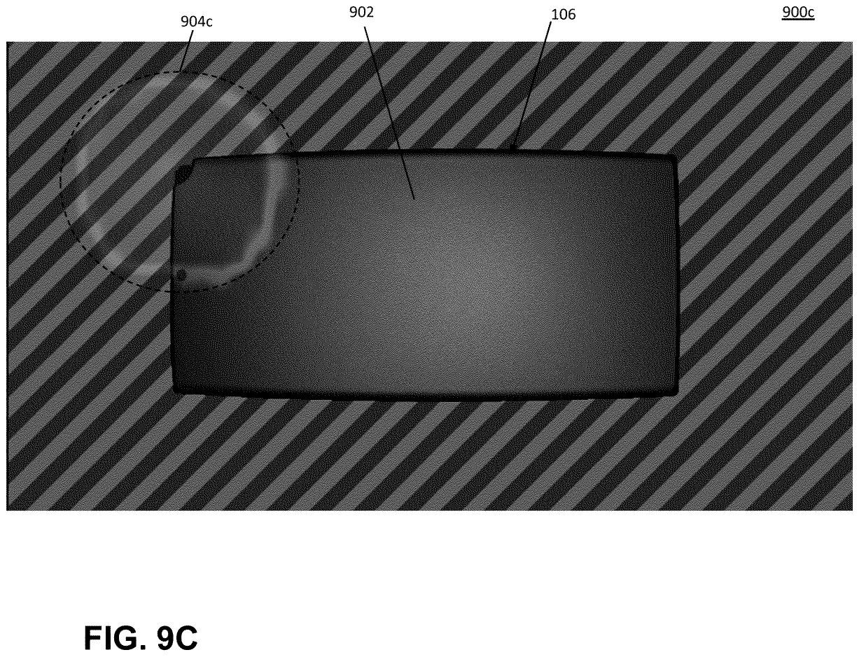

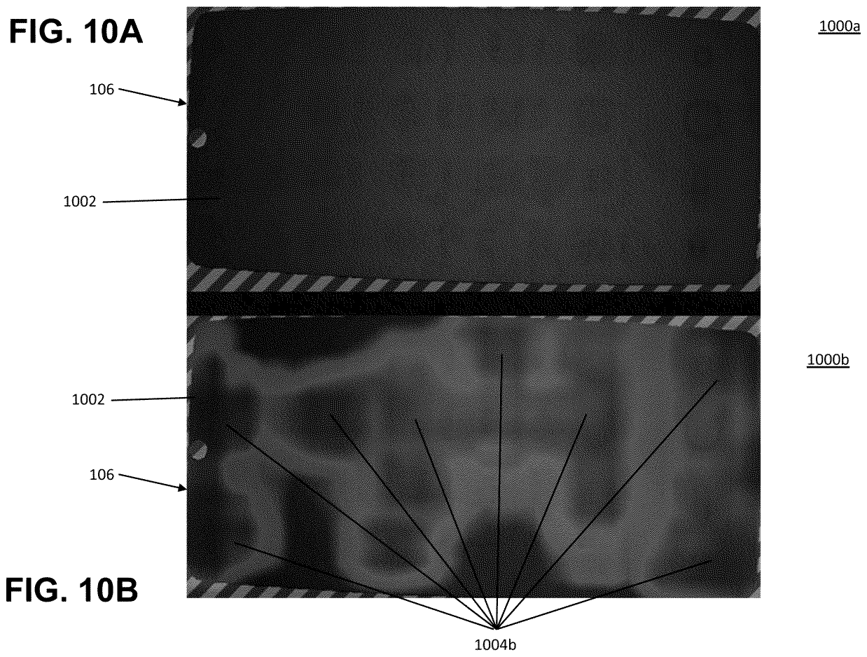

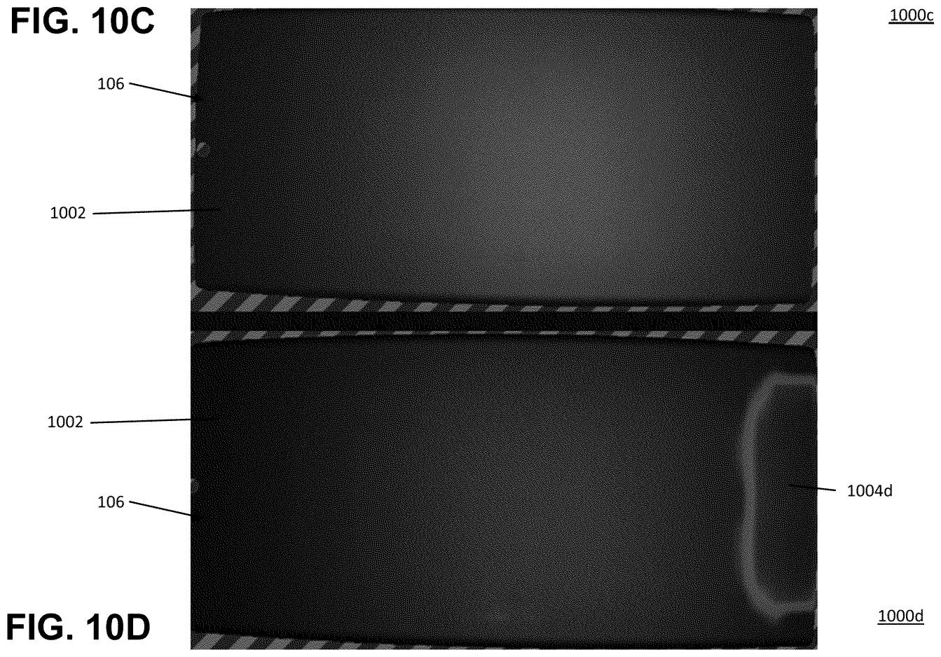

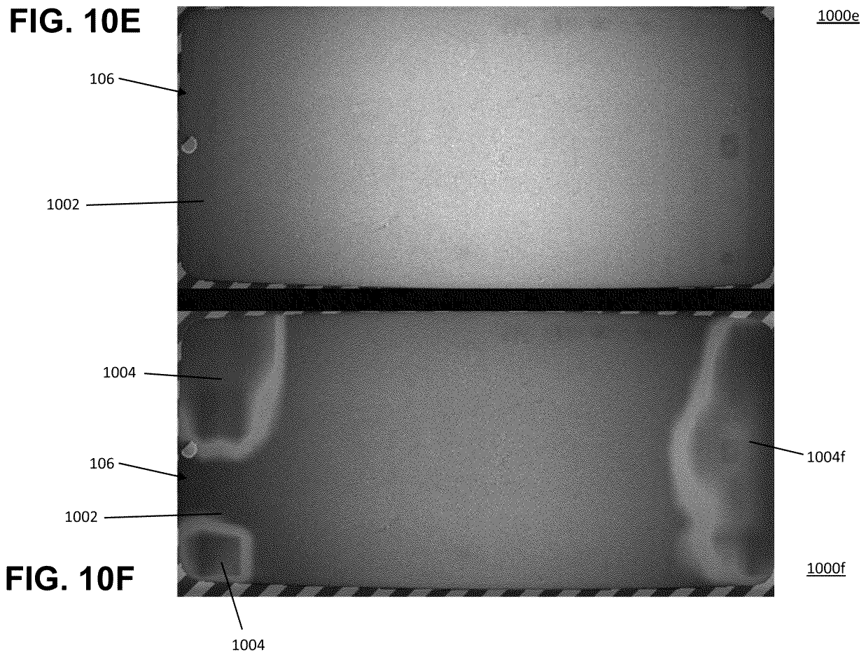

FIGS. 9A-9C illustrate example images 900a-900c associated with screen condition detection in accordance with various embodiments of the present disclosure. For example, the embodiment of FIGS. 9A-9C illustrates an example bruising analysis performed on example mobile devices. Bruising may refer to a type of damage that occurs to screens, typically from physical damage (e.g., impacts, water damage, pressure spots), that causes the pixels to discolor, bleed, or otherwise operate incorrectly or fail to operate. The images 900a-900c illustrate bruises as clusters of damage centered around black spots. The images 900a-900c illustrate the mobile devices 106 including the screen 902 of the mobile devices 106. For example, the depicted images 900a-900c are masked (e.g., via a preprocessing masking model) to show only the device screens with the surrounding bezels removed. As will be noted between the embodiments of FIGS. 9A-9C on the one hand and FIGS. 10A-10F on the other hand, in some embodiments, different masking models and/or different masking settings may be applied. For example, the images 900a-c of FIGS. 9A-9C have a lighter masking that preserves the camera in the center-left of the mobile device screens, whereas the images 1000a-1000f of FIGS. 10A-10F have a heavier mask that removes the cameras from the screen images. The images, post masking, may be fed into one or more models (e.g., neural networks) in accordance with the various pixel degradation classification models discussed herein.

Additionally, the images 900a-900c may provide pixel degradation information 904a-904c associated with the screen 902 via an overlay over the captured image or a modification of the captured image. For example, the images 900a-900c as depicted have been augmented with the pixel degradation information 904a-904c provided via a trained model of the one or more trained models 120. In some embodiments, the pixel degradation information 904a-904c may be related to a pixel degradation classification provided via a trained model of the one or more trained models 120. In some embodiments, the pixel degradation information 904a-904c may indicate a degree of pixel degradation (e.g., a degree of screen bruising) for one or more pixels of the screens 902.

In some embodiments, the screen condition detection apparatus 102 may determine a percentage of the screen 902 associated with pixel degradation based on the pixel degradation information 904a-904c (e.g., an analysis or grading of the screen quality as a whole based upon the identified pixel regions showing degradation), which analysis may be tuned to one or more thresholds or weighted via one or more weights to inform the final screen condition analysis. For example, the screen condition detection apparatus 102 considering the image 900a according to FIG. 9A output a “71.2% bruised” output in response to the depicted analysis; the screen condition detection apparatus 102 considering the image 900b according to FIG. 9B output a “65.8% bruised” output in response to the depicted analysis; and the screen condition detection apparatus 102 considering the image 900c according to FIG. 9C output a “64.4% bruised” output in response to the depicted analysis. In some embodiments, the screen condition detection apparatus 102 may determine a percentage of pixels of the screens 902 associated with pixel degradation based on the pixel degradation information 904a-904c. In some embodiments, the screen condition detection apparatus 102 may determine a screen condition for the screen 902 based on a comparison between the percentage and a defined threshold value associated with the screen condition. In some embodiments, such as the embodiment shown in FIGS. 9A-9C, the images 900a-900c may be a heatmap image associated with the screen 902 that is based on the pixel degradation information 904a-904c with severity of degradation (e.g., bruising) shown in reddening colors (e.g., with blue/grey showing no to minimal degradation and dark red showing severe degradation).

FIGS. 10A-10F illustrate example images 1000a-1000f associated with screen condition detection in accordance with various embodiments of the present disclosure. For example, the embodiment of FIGS. 10A-10F illustrates an example burn-in analysis performed on example mobile devices. Burn-in may refer to a permanent discoloration of one or more areas of a screen caused by, for example, cumulative use of the discolored areas of the screen (e.g., an outline of an icon that is frequently displayed on the same place of the screen). The images 1000a-1000f illustrate examples of the mobile device 106 and a screen 1002 of the mobile device 106. For example, the depicted images 1000a-1000f are masked (e.g., via a preprocessing masking model) to show only the device screen with the surrounding bezel removed. Additionally, the images 1000a-1000f may provide pixel degradation information 1004b, d, f associated with the screen 1002 via an overlay over the captured image or a modification of the captured image. For example, the images 1000b, 1000d, and 1000f illustrate the respective images 1000a, 1000c, and 1000e augmented with the pixel degradation information 1004b, d, f provided via a trained model of the one or more trained models 120. In some embodiments, the pixel degradation information 1004b, d, f may be related to a pixel degradation classification provided via a trained model of the one or more trained models 120. In some embodiments, the pixel degradation information 1004b, d, f may indicate a degree of pixel degradation (e.g., a degree of screen burn-in) for one or more pixels of the screen 1002, such as via heat map.

In some embodiments, the screen condition detection apparatus 102 may determine a percentage of the screen 1002 associated with pixel degradation based on the pixel degradation information 1004b, d, f (e.g., an analysis or grading of the screen quality as a whole based upon the identified pixel regions showing degradation), which analysis may be tuned to one or more thresholds or weighted via one or more weights to inform the final screen condition analysis. For example, the screen condition detection apparatus 102 considering the image 1000a according to FIG. 10A output a “99.8% bad” output in response to the depicted analysis, which translated to the heat map shown in the image 1000b according to FIG. 10B; the screen condition detection apparatus 102 considering the image 1000c according to FIG. 10C output a “64.4% bad” output in response to the depicted analysis, which translated to the heat map shown in the image 1000d according to FIG. 10D; and the screen condition detection apparatus 102 considering the image 1000e according to FIG. 10E output a “90.8% bad” output in response to the depicted analysis, which translated to the heat map shown in the image 1000f according to FIG. 10F. In some embodiments, the screen condition detection apparatus 102 may determine a percentage of pixels of the screen 1002 associated with pixel degradation based on the pixel degradation information 1004b, d, f. In some embodiments, the screen condition detection apparatus 102 may determine a screen condition for the screen 1002 based on a comparison between the percentage and a defined threshold value associated with the screen condition. In some embodiments, the image 1000a-1000f may be a heatmap image associated with the screen 1002 that is based on the pixel degradation information 1004b, d, f.

### Example System Control and Analysis

Having described example systems and apparatuses, related data flows, and user interfaces in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depict a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

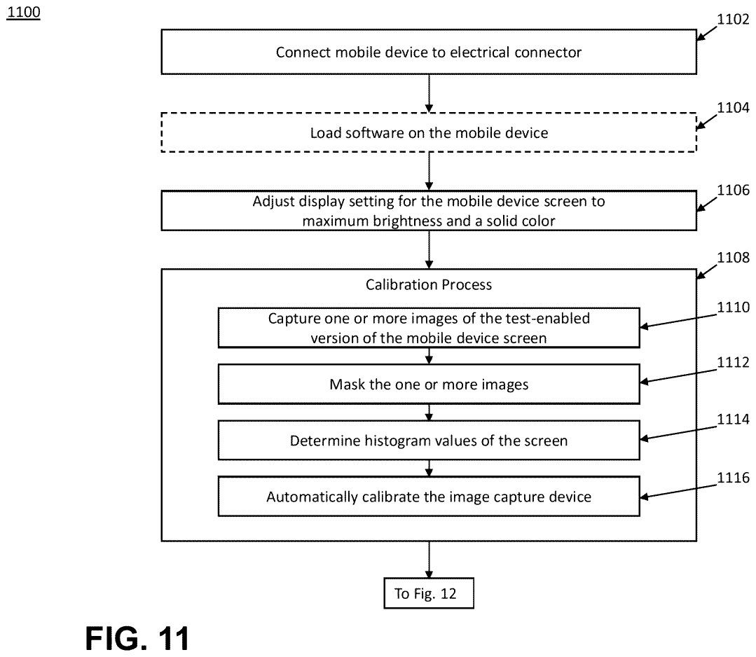

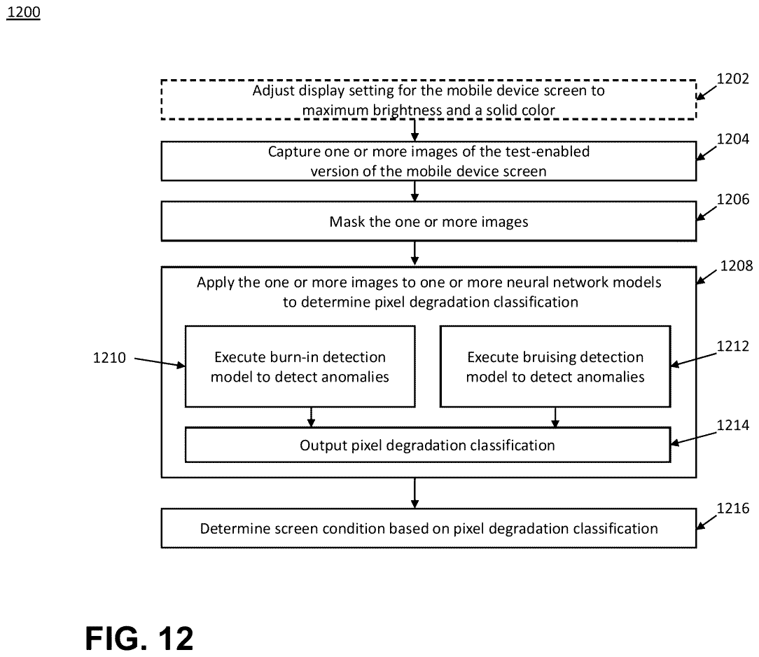

FIGS. 11 and 12 illustrate processes 1100, 1200 depicting example operations for providing screen condition detection associated with a screen of mobile device in accordance with one or more embodiments of the present disclosure. The processes 1100, 1200 of FIGS. 11 and 12 may be performed together (e.g., sequentially) and/or individually to achieve the out put of each respective process. The processes 1100, 1200 embody an example computer-implemented method. In some embodiments, the processes 1100, 1200 are embodied by computer program code stored on a non-transitory computer-readable storage medium of a computer program product configured for execution to perform the process as depicted and described. Alternatively or additionally, in some embodiments, the processes 1100, 1200 are performed by one or more specially configured computing devices, such as the screen condition detection apparatus 102 alone or in communication with one or more other component(s), device(s), system(s), and/or the like. In this regard, in some embodiments, the screen condition detection apparatus 102 is specially configured by computer-coded instructions (e.g., computer program instructions) stored thereon, for example in the memory 204 and/or another component depicted and/or described herein and/or otherwise accessible to the screen condition detection apparatus 102, for performing the operations as depicted and described. In some embodiments, the screen condition detection apparatus 102 is in communication with one or more external apparatus(es), system(s), device(s), and/or the like, to perform one or more of the operations as depicted and described. For example, the screen condition detection apparatus 102 in some embodiments is in communication with and/or incorporated as part of the mobile device engagement system 104. For purposes of simplifying the description, the processes 1100, 1200 are described as performed by and from the perspective of the screen condition detection apparatus 102.

According to some examples, a first process 1100 or first portion of an overall process 1100, 1200 may begin following the robot arm engaging the mobile device with a station, such as is shown and described in U.S. application Ser. No. 18/990,549, filed Dec. 20, 2024, and entitled “Robot Enabled Mobile Device Manipulation System, Method, And Apparatus”, which application is incorporated by reference herein in its entirety. For example, process 1100 may include connecting the mobile device to the electrical connector (e.g., connector 608 as shown in FIG. 7), as shown at block 1102.

Via the electrical connection, in some embodiments, the process 1100 may include loading software onto the mobile device 1104, as shown at block 1104. The software may comprise any of the embodiments discussed herein, including but not limited to a mobile application or a browser based program. In some embodiments, the software may be configured to run one or more electronic diagnostics on the mobile device in addition to facilitating portions of the pixel degradation classification process described herein. In some embodiments, various commands may be sent to the mobile device for execution with or without dedicated software installed thereon. For example, simulated keystrokes or mouse inputs may be used to cause the mobile device to configure the test-enabled version of the screen.

In some example embodiments, the process 1100 may include adjusting at least one display setting for the mobile device screen to provide a test-enabled version of the screen, as shown at block 1106. For example, the depicted adjustment comprises setting the mobile device screen to maximum brightness and configuring the screen to output a solid color (e.g., white, green, etc.). For example, the screen condition detection apparatus 102 may adjust one or more display settings (e.g., brightness) for a screen of a mobile device based at least in part on one or more mobile device attributes associated with the mobile device to provide a test-enabled version of the screen. For example, a device make, model, or operating system may inform the type of software and/or the instructions that must be executed on the mobile device to cause the display setting adjustment.

According to some examples, the process 1100 may enter a calibration process 1108 whereby the image capture device (or image capture devices) may be calibrated to produce a standardized output, which standardized output may be used as an input to the various models discussed herein. In some embodiments, the calibration process 1108 may include capturing one or more images of the test-enabled version of the mobile device screen via at least one image capture device, as shown at block 1110. For example, the one or more images may be greyscale images in some embodiments. In at least some embodiments, the calibration process 1108 may then include masking the one or more images to isolate the screen, as shown at block 1112. The calibration process 1108 may further include determining histogram values for the one or more images, as shown at block 1114. The histogram values may be calculated based on binning each respective image in view of the light intensity associated with a plurality of pixels in the captured image(s). In some embodiments, a histogram value may be the quantity or percentage of the image having pixel intensity values in a target range. In some embodiments, the histogram values may be a plot of pixel intensity versus quantity of pixels. Based on the histogram values, the calibration process 1108 may then automatically calibrate the at least one image capture device, for example, by adjusting one or more settings or other values associated with the one or more image capture devices, such as an exposure setting, to cause the image capture device to output a standardized image with a standard histogram value, as shown at block 1116. For example, the exposure may be adjusted such that the one or more image capture devices output images of the mobile device screen with a peak of the histogram values in the 130-140 intensity range (e.g., 130-140 in the 0 to 255 range of a byte associated with the pixel). In some embodiments, multiple subsequent images may be captured as needed to verify or adjust the calibration. The calibration may be performed for each device, for each device sharing a common attribute, for various portions of a device (e.g., front or back), or the like.

With reference to FIG. 12, the process 1200 may include adjusting one or more display settings for the mobile device screen, as shown at block 1202. In some embodiments, the mobile device screen may retain the setting originally set at block 1106 through each image capture process, and some embodiments, multiple setting processes may occur. The adjustment of the screen may not require changing a setting if the screen is already set at the target setting. As described above, the display setting may include maximum brightness and/or a predetermined color and/or pattern (e.g., solid white or green). Following the display setting adjustment, the screen may be in a test-enabled version of the mobile device screen.

At least according to some embodiments, the process 1200 may include capturing one or more images of the test-enabled version of the mobile device screen via the image capture device(s), as shown at block 1204. The process 1200 may include masking the one or more images, as shown in block 1206. In some embodiments, different masking processes may be applied for each model into which the image may be input. For example, in some embodiments discussed herein, a bruising model (e.g., as performed at step 1212) may use a lighter (also referred to as broader) masking process than a burn-in model (e.g., as performed at step 1210). In such embodiments, the masked image to be analyzed by the bruising model may include more area of the mobile device than the masked image to be analyzed by the burn-in model. Conversely, the masked image to be analyzed by the bruising model runs a higher risk of unrelated (e.g., non-screen) portions of the mobile device being analyzed than the burn-in model in the above-described embodiment.

In some embodiments, the process 1200 may include applying the one or more images (e.g., the masked images) to one or more neural network models to determine pixel degradation classifications, as shown at block 1208. In the depicted embodiment, block 1208 includes two sub-blocks, which include applying the respective masked images to each of the burn-in detection model and the bruising detection model, which models are separately trained neural networks configured to detect, respectively, burn-in and bruising of the screen. Various other models may be used in addition to the depicted models. In some embodiments, one of the depicted models may be used without the other.

The process 1200 may include outputting a pixel degradation classification associated with the mobile device as shown at block 1214. In some embodiments, the pixel degradation classification may include separate outputs for each model (e.g., a burn-in score and/or a bruising score) or a cumulative output reflecting both (e.g., weighted based on the number of models executed). For example, in some embodiments, the respective models and outputs may include detecting one or more anomalies on the screen (e.g., via the neural network models), generating a heatmap of the identified anomalies, and/or generating one or more confidence levels and/or scores associated with the identified anomalies. In some embodiments, the heat maps may be generated for each respective model. In some embodiments, the heat maps may be generated cumulatively for all of the models. The heat maps may be generated based on the location, number, size, or other attributes associated with the detected anomalies.

The process 1200 may further include determining a screen condition based on the pixel degradation classification as shown at block 1216. In some embodiments, determining the screen condition may comprise generating renderable data displaying the pixel degradation classification(s). In some embodiments, determining the screen condition may comprise combining and/or analyzing the pixel degradation classifications (e.g., distilling the classification model outputs into a score or other variable output, such as “major”, “minor”, or “no” degradation). The output may comprise a report and/or one or more next steps for execution on the mobile device (e.g., one or more refurbishment steps, one or more grades, or the like).

In some embodiments, the processes 1100, 1200 shown and described with respect to FIGS. 11-12 may be performed after other process steps in an overall mobile device processing flow. For example, in some embodiments, the mobile devices may be graded according to a cosmetic condition of the mobile devices prior to the pixel degradation classification operations. In some embodiments, by way of non-limiting example, only devices which pass the cosmetic condition analysis may be analyzed for pixel degradation.

In some embodiments, the screen condition associated with the screen of the mobile device (e.g., the mobile device 106) may trigger one or more downstream processes. For example, a repair for the mobile device 106 may be triggered based on the determined screen condition (e.g., in response to a determination that the mobile device 106 is associated with screen burn-in or screen bruising). In another example, a notification may be presented via a user interface of another mobile device or another computing device based on the screen condition. In yet another example, a hardware component of another mobile device (e.g., the mobile device 106) or a server device may be controlled based on the screen condition associated with the mobile device (e.g., the mobile device 106). In yet another example, a value (e.g., a trade-in value) of the mobile device 106 may be determined based on the determined screen condition. In yet another example, a repair recommendation (e.g., replace the screen) for the mobile device 106 may be determined based on the determined screen condition. In yet another example, it may be determined whether the mobile device 106 qualifies for a particular service (e.g., whether the mobile device 106 is eligible for one or more downstream channels) based on the determined screen condition. In yet another example, one or more automated instructions and/or actions may be initiated between devices, systems, servers, networks, etc. based on the condition associated with the mobile device (e.g., the mobile device 106). In some embodiments, the screen condition associated with the screen of the mobile device (e.g., the mobile device 106) may trigger the one or more downstream processes in response to a determination that the screen condition satisfies a predefined screen condition (e.g., a certain degree of pixel degradation).

Although an example processing system has been described above, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, i.e., one or more modules of computer program instructions, encoded on computer storage medium for execution by, or to control the operation of, information/data processing apparatus. Alternatively, or in addition, the program instructions may be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium may also be, or be included in, one or more separate physical components or media (e.g., multiple CDs, disks, or other storage devices).

The operations described herein may be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus may include special purpose logic circuitry, e.g., an FPGA (field programmable gate array) or an ASIC (application-specific integrated circuit). The apparatus may also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment may realize various different computing model infrastructures, such as web services, distributed computing and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments of the subject matter described herein may be implemented on a computer having a display device, e.g., a CRT (cathode ray tube) or LCD (liquid crystal display) monitor, for displaying information/data to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Embodiments of the subject matter described herein may be implemented in a computing system that includes a back-end component, e.g., as an information/data server, or that includes a middleware component, e.g., an application server, or that includes a front-end component, e.g., a client computer having a graphical user interface or a web browser through which a user may interact with an implementation of the subject matter described herein, or any combination of one or more such back-end, middleware, or front-end components. The components of the system may be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system may include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) may be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising one or more processors and one or more storage devices storing instructions that are operable, when executed by the one or more processors, to cause the one or more processors to: adjust one or more display settings for a screen of a mobile device based at least in part on one or more mobile device attributes associated with the mobile device to provide a test-enabled version of the screen; capture at least one image of the test-enabled version of the screen via an image capture device; apply a neural network model to the at least one image to determine a pixel degradation classification for the screen; and determine a screen condition for the screen based at least in part on the pixel degradation classification for the screen.

Clause 2. The apparatus of clause 1, wherein the one or more storage devices store instructions that are operable, when executed by the one or more processors, to further cause the one or more processors to: adjust one or more settings of the image capture device prior to the capture of the at least one image of the test-enabled version of the screen via the image capture device.

Clause 3. The apparatus of any one of the foregoing clauses, wherein the one or more settings comprise an exposure setting.

Clause 4. The apparatus of any one of the foregoing clauses, wherein the one or more storage devices store instructions that are operable, when executed by the one or more processors, to further cause the one or more processors to: capture a first image of the test-enabled version of the screen via the image capture device; analyze the first image to determine one or more histogram attributes associated with the first image; calibrate one or more settings of the image capture device based at least in part on the one or more histogram attributes to provide a calibrated version of the image capture device for the test-enabled version of the screen; capture a second image of the test-enabled version of the screen via the calibrated version of the image capture device; and apply the neural network model to the second image to determine the pixel degradation classification for the screen.

Clause 5. The apparatus of any one of the foregoing clauses, wherein the one or more storage devices store instructions that are operable, when executed by the one or more processors, to further cause the one or more processors to: control a robot arm to enable a connection between a port of the mobile device and an electrical connector of a mobile device engagement system, wherein the robot arm is configured to engage and facilitate positioning of the mobile device with respect to the mobile device engagement system; and responsive to the port of the mobile device being connected to the electrical connector of the mobile device engagement system, initiate transmission of one or more signals between the mobile device engagement system and the mobile device to cause adjustment of the one or more display settings for the screen of the mobile device.

Clause 6. The apparatus of any one of the foregoing clauses, wherein the one or more storage devices store instructions that are operable, when executed by the one or more processors, to further cause the one or more processors to: select the neural network model from a plurality of neural network models based at least in part on the one or more mobile device attributes.

Clause 7. The apparatus of clause 6, wherein the one or more storage devices store instructions that are operable, when executed by the one or more processors, to further cause the one or more processors to: capture an image of the mobile device via the image capture device; and analyze the image to determine the one or more mobile device attributes.

Clause 8. The apparatus of any one of the foregoing clauses, wherein the one or more storage devices store instructions that are operable, when executed by the one or more processors, to further cause the one or more processors to: apply image masking to the at least one image to generate at least one masked image; and apply the neural network model to the at least one masked image to determine a pixel degradation classification for respective pixels of the screen.

Clause 9. The apparatus of any one of the foregoing clauses, wherein the one or more storage devices store instructions that are operable, when executed by the one or more processors, to further cause the one or more processors to: determine a percentage of the screen associated with pixel degradation based at least in part on the pixel degradation classification for the respective pixels of the screen; and determine the screen condition based at least in part on a comparison between the percentage and a defined threshold value associated with the screen condition.

Clause 10. The apparatus of any one of the foregoing clauses, wherein the one or more storage devices store instructions that are operable, when executed by the one or more processors, to further cause the one or more processors to: generate a heatmap image associated with the screen based at least in part on the pixel degradation classification for the respective pixels of the screen.

Clause 11. The apparatus of any one of the foregoing clauses, wherein the neural network model is trained based at least in part on an image dataset associated with desirable pixel quality for mobile devices.

Clause 12. The apparatus of any one of the foregoing clauses, wherein the neural network model is trained based at least in part on a first image dataset associated with pixel degradation and a second image dataset associated with desirable pixel quality.

13. The apparatus of any one of the foregoing clauses, wherein the one or more storage devices store instructions that are operable, when executed by the one or more processors, to further cause the one or more processors to: initiate retraining of the neural network model based at least in part on the at least one image in response to a determination that the screen condition satisfies defined screen condition criteria.

Clause 14. A computer-implemented method, comprising: adjusting one or more display settings for a screen of a mobile device based at least in part on one or more mobile device attributes associated with the mobile device to provide a test-enabled version of the screen; capturing at least one image of the test-enabled version of the screen via an image capture device; applying a neural network model to the at least one image to determine a pixel degradation classification for the screen; and determining a screen condition for the screen based at least in part on the pixel degradation classification for the screen.

Clause 15. The computer-implemented method of clause 14, further comprising: adjusting one or more settings of the image capture device prior to the capture of the at least one image of the test-enabled version of the screen via the image capture device.

Clause 16. The computer-implemented method of any one clauses 14-15, further comprising: capturing a first image of the test-enabled version of the screen via the image capture device analyzing the first image to determine one or more histogram attributes associated with the first image; calibrating one or more settings of the image capture device based at least in part on the one or more histogram attributes to provide a calibrated version of the image capture device for the test-enabled version of the screen; capturing a second image of the test-enabled version of the screen via the calibrated version of the image capture device; and applying the neural network model to the second image to determine the pixel degradation classification for the screen.

Clause 17. The computer-implemented method of any one of clauses 14-16, further comprising: controlling a robot arm to enable a connection between a port of the mobile device and an electrical connector of a mobile device engagement system, wherein the robot arm is configured to engage and facilitate positioning of the mobile device with respect to the mobile device engagement system; and responsive to the port of the mobile device being connected to the electrical connector of the mobile device engagement system, initiating transmission of one or more signals between the mobile device engagement system and the mobile device to cause adjustment of the one or more display settings for the screen of the mobile device.

Clause 18. The computer-implemented method of any one of clauses 14-17, further comprising: selecting the neural network model from a plurality of neural network models based at least in part on the one or more mobile device attributes.

Clause 19. The computer-implemented method of any one of clauses 14-18, further comprising: applying image masking to the at least one image to generate at least one masked image; and applying the neural network model to the at least one masked image to determine a pixel degradation classification for respective pixels of the screen.

Clause 20. A computer program product, stored on at least one computer readable medium, comprising instructions that when executed by one or more computers cause the one or more computers to: adjust one or more display settings for a screen of a mobile device data based at least in part on one or more mobile device attributes associated with the mobile device to provide a test-enabled version of the screen; capture at least one image of the test-enabled version of the screen via an image capture device; apply a neural network model to the at least one image to determine a pixel degradation classification for the screen; and determine a screen condition for the screen based at least in part on the pixel degradation classification for the screen.

Clause 21. A robotic system comprising: a robot arm comprising an end effector configured to engage a mobile device; an image capture device connected to and movable with at least a portion of the robot arm; and one or more computing devices comprising one or more processors and one or more storage devices storing instructions that are operable, when executed by the one or more processors, to cause the one or more processors to: cause the image capture device to capture at least one image of a screen of the mobile device; and apply the at least one image to a trained model to determine a condition of the screen.

Clause 22. The robotic system of clause 21, wherein the trained model comprises a trained neural network, and wherein the condition of the screen comprises a pixel degradation classification for the screen.

Clause 23. The robotic system of any one of clauses 21-22, wherein the pixel degradation classification comprises an indication of burn-in and/or bruising on the mobile device screen.

Clause 24. The robotic system of any one of clauses 21-23, wherein the instructions are further operable, when executed by the one or more processors, to cause the one or more processors to: cause the robot arm to engage and hold the mobile device with the end effector; and cause the robot arm to move the mobile device into engagement with a mobile device engagement system by causing a port of the mobile device and an electrical connector of the mobile device engagement system to physically engage.

Clause 25. The robotic system of any one of clauses 21-24, wherein the instructions are further operable, when executed by the one or more processors, to cause the one or more processors to cause the image capture device to capture the at least one image of the screen of the mobile device after the physical engagement of the port of the mobile device and the electrical connector of the mobile device engagement system.

Clause 26. The robotic system of any one of clauses 21-25, wherein the instructions are further operable, when executed by the one or more processors, to adjust one or more display settings for the screen of the mobile device using signals sent via the physical engagement between the port of the mobile device and the electrical connector of the mobile device engagement system.

Clause 27. The robotic system of any one of clauses 21-26, wherein the instructions are further operable, when executed by the one or more processors, to cause the one or more processors to: cause the robot arm to move to a first position to engage the mobile device with the end effector; and cause the robot arm to move to a second position to capture the at least one image of the screen of the mobile device with the image capture device.

Clause 28. The robotic system of any one of clauses 21-27, wherein the end effector is within a field of view of the image capture device.

Clause 29. The robotic system of any one of clauses 21-28, wherein the image capture device is attached to a portion of the robot arm defined between the end effector and a base of the robot arm.

Clause 30. A computer-implemented method comprising: capturing at least one image of a screen of a mobile device with an image capture device connected to and movable with at least a portion of a robot arm; and applying the at least one image to a trained model to determine a condition of the screen.

Clause 31. The computer-implemented method of clause 30, wherein the trained model comprises a trained neural network, and wherein the condition of the screen comprises a pixel degradation classification for the screen.

Clause 32. The computer-implemented method of any one of clauses 30-31, wherein the pixel degradation classification comprises an indication of burn-in and/or bruising on the mobile device screen.

Clause 33. The computer-implemented method of any one of clauses 30-32, further comprising: causing the robot arm to engage and hold the mobile device with an end effector; and causing the robot arm to move the mobile device into engagement with a mobile device engagement system by causing a port of the mobile device and an electrical connector of the mobile device engagement system to physically engage.

Clause 34. The computer-implemented method of any one of clauses 30-33, further comprising: capturing the at least one image of the screen of the mobile device after the physical engagement of the port of the mobile device and the electrical connector of the mobile device engagement system.

Clause 35. The computer-implemented method of any one of clauses 30-34, further comprising: sending signals via the physical engagement between the port of the mobile device and the electrical connector of the mobile device engagement system to adjust one or more display settings for the screen of the mobile device.

Clause 36. The computer-implemented method of any one of clauses 30-35, further comprising: causing the robot arm to move to a first position to engage the mobile device with the end effector; and causing the robot arm to move to a second position to capture the at least one image of the screen of the mobile device with the image capture device.

Clause 37. The computer-implemented method of any one of clauses 30-36, wherein the end effector is within a field of view of the image capture device.

Clause 38. The computer-implemented method of any one of clauses 30-37, wherein the image capture device is attached to a portion of the robot arm defined between the end effector and a base of the robot arm.

Clause 39. A computer program product, stored on at least one computer readable medium, comprising instructions that when executed by one or more computers cause the one or more computers to: capture at least one image of a screen of a mobile device with an image capture device connected to and movable with at least a portion of a robot arm; and apply the at least one image to a trained model to determine a condition of the screen.

Clause 40. The computer program product of clause 39, wherein the trained model comprises a trained neural network, wherein the condition of the screen comprises a pixel degradation classification for the screen, and wherein the pixel degradation classification comprises an indication of burn-in and/or bruising on the mobile device screen.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus comprising one or more processors and one or more storage devices storing instructions that are operable, when executed by the one or more processors, to cause the one or more processors to:
adjust one or more display settings for a screen of a mobile device based at least in part on one or more mobile device attributes associated with the mobile device to provide a test-enabled version of the screen;
capture at least one image of the test-enabled version of the screen via an image capture device;
apply a neural network model to the at least one image to determine a pixel degradation classification for the screen; and
determine a screen condition for the screen based at least in part on the pixel degradation classification for the screen.

2. The apparatus of claim 1, wherein the one or more storage devices store instructions that are operable, when executed by the one or more processors, to further cause the one or more processors to:
adjust one or more settings of the image capture device prior to the capture of the at least one image of the test-enabled version of the screen via the image capture device.

3. The apparatus of claim 2, wherein the one or more settings comprise an exposure setting.

4. The apparatus of claim 1, wherein the one or more storage devices store instructions that are operable, when executed by the one or more processors, to further cause the one or more processors to:
capture a first image of the test-enabled version of the screen via the image capture device;
analyze the first image to determine one or more histogram attributes associated with the first image;
calibrate one or more settings of the image capture device based at least in part on the one or more histogram attributes to provide a calibrated version of the image capture device for the test-enabled version of the screen;
capture a second image of the test-enabled version of the screen via the calibrated version of the image capture device; and
apply the neural network model to the second image to determine the pixel degradation classification for the screen.

5. The apparatus of claim 1, wherein the one or more storage devices store instructions that are operable, when executed by the one or more processors, to further cause the one or more processors to:
control a robot arm to enable a connection between a port of the mobile device and an electrical connector of a mobile device engagement system, wherein the robot arm is configured to engage and facilitate positioning of the mobile device with respect to the mobile device engagement system; and
responsive to the port of the mobile device being connected to the electrical connector of the mobile device engagement system, initiate transmission of one or more signals between the mobile device engagement system and the mobile device to cause adjustment of the one or more display settings for the screen of the mobile device.

6. The apparatus of claim 1, wherein the one or more storage devices store instructions that are operable, when executed by the one or more processors, to further cause the one or more processors to:
select the neural network model from a plurality of neural network models based at least in part on the one or more mobile device attributes.

7. The apparatus of claim 6, wherein the one or more storage devices store instructions that are operable, when executed by the one or more processors, to further cause the one or more processors to:
capture an image of the mobile device via the image capture device; and
analyze the image to determine the one or more mobile device attributes.

8. The apparatus of claim 1, wherein the one or more storage devices store instructions that are operable, when executed by the one or more processors, to further cause the one or more processors to:
apply image masking to the at least one image to generate at least one masked image; and
apply the neural network model to the at least one masked image to determine a pixel degradation classification for respective pixels of the screen.

9. The apparatus of claim 1, wherein the one or more storage devices store instructions that are operable, when executed by the one or more processors, to further cause the one or more processors to:
determine a percentage of the screen associated with pixel degradation based at least in part on the pixel degradation classification for the respective pixels of the screen; and
determine the screen condition based at least in part on a comparison between the percentage and a defined threshold value associated with the screen condition.

10. The apparatus of claim 1, wherein the one or more storage devices store instructions that are operable, when executed by the one or more processors, to further cause the one or more processors to:
generate a heatmap image associated with the screen based at least in part on the pixel degradation classification for the respective pixels of the screen.

11. The apparatus of claim 1, wherein the neural network model is trained based at least in part on an image dataset associated with desirable pixel quality for mobile devices.

12. The apparatus of claim 1, wherein the neural network model is trained based at least in part on a first image dataset associated with pixel degradation and a second image dataset associated with desirable pixel quality.

13. The apparatus of claim 1, wherein the one or more storage devices store instructions that are operable, when executed by the one or more processors, to further cause the one or more processors to:
initiate retraining of the neural network model based at least in part on the at least one image in response to a determination that the screen condition satisfies defined screen condition criteria.

14. A computer-implemented method, comprising:
adjusting one or more display settings for a screen of a mobile device based at least in part on one or more mobile device attributes associated with the mobile device to provide a test-enabled version of the screen;
capturing at least one image of the test-enabled version of the screen via an image capture device;
applying a neural network model to the at least one image to determine a pixel degradation classification for the screen; and
determining a screen condition for the screen based at least in part on the pixel degradation classification for the screen.

15. The computer-implemented method of claim 14, further comprising:
adjusting one or more settings of the image capture device prior to the capture of the at least one image of the test-enabled version of the screen via the image capture device.

16. The computer-implemented method of claim 14, further comprising:
capturing a first image of the test-enabled version of the screen via the image capture device;
analyzing the first image to determine one or more histogram attributes associated with the first image;
calibrating one or more settings of the image capture device based at least in part on the one or more histogram attributes to provide a calibrated version of the image capture device for the test-enabled version of the screen;
capturing a second image of the test-enabled version of the screen via the calibrated version of the image capture device; and
applying the neural network model to the second image to determine the pixel degradation classification for the screen.

17. The computer-implemented method of claim 14, further comprising:
controlling a robot arm to enable a connection between a port of the mobile device and an electrical connector of a mobile device engagement system, wherein the robot arm is configured to engage and facilitate positioning of the mobile device with respect to the mobile device engagement system; and
responsive to the port of the mobile device being connected to the electrical connector of the mobile device engagement system, initiating transmission of one or more signals between the mobile device engagement system and the mobile device to cause adjustment of the one or more display settings for the screen of the mobile device.

18. The computer-implemented method of claim 14, further comprising:
selecting the neural network model from a plurality of neural network models based at least in part on the one or more mobile device attributes.

19. The computer-implemented method of claim 14, further comprising:
applying image masking to the at least one image to generate at least one masked image; and
applying the neural network model to the at least one masked image to determine a pixel degradation classification for respective pixels of the screen.

20. A computer program product, stored on at least one computer readable medium, comprising instructions that when executed by one or more computers cause the one or more computers to:
adjust one or more display settings for a screen of a mobile device data based at least in part on one or more mobile device attributes associated with the mobile device to provide a test-enabled version of the screen;
capture at least one image of the test-enabled version of the screen via an image capture device;
apply a neural network model to the at least one image to determine a pixel degradation classification for the screen; and
determine a screen condition for the screen based at least in part on the pixel degradation classification for the screen.
